(19) United States
(12) Patent Application Publication
(10) Pub. No.: US 2015/0256654 A1
(43) Pub. Date: Sep. 10, 2015

(54) COMMUNICATION METHOD, RECORDING MEDIUM HAVING COMMUNICATION CONTROL PROGRAM RECORDED THEREIN, AND COMMUNICATION APPARATUS

(71) Applicant: FUJITSU LIMITED, Kawasaki-shi (JP)

(72) Inventor: Naoki OGUCHI, Kawasaki (JP)

(21) Appl. No.: 14/612,313

(22) Filed: Feb. 3, 2015

(30) Foreign Application Priority Data
Mar. 6, 2014 (JP) 2014-043938

(51) Int. Cl. H04L 29/06; G06F 11/14; H04L 12/26; H04L 12/24; H04L 29/08

(52) U.S. Cl. CPC H04L 69/08; H04L 41/0226; H04L 67/10; H04L 43/0841; G06F 11/1451; G06F 2201/84

(57) ABSTRACT

Before detecting a protocol switch trigger, transmission data of a first protocol is redundantly written into a transmission buffer for the first protocol. The transmission data of the first protocol is the same as transmission data of a second protocol. Upon detecting the protocol switch trigger, the second protocol is switched to the first protocol.

### CROSS-REFERENCE TO RELATED APPLICATION

This application is based upon and claims the benefit of priority of the prior Japanese Patent Application No. 2014-043938, filed on Mar. 6, 2014, the entire contents of which are incorporated herein by reference.

### FIELD

The embodiments discussed herein are related to a communication method, a recording medium having a communication control program recorded therein, and a communication apparatus.

### BACKGROUND

Patent Documents D1 to D4 listed below disclose methods of switching a protocol used for communication between a transmitter and a receiver to one of a UDP (user datagram protocol) and a TCP (transmission control protocol) according to communication quality.

D1: JP 2001-298479 A

D2: JP 2003-125020 A

D3: JP 2001-142488 A

D4: JP 2000-151680 A

However, all of D1 to D4 does not mention to or consider that upon switching protocols in response to a detection of a switch trigger of the protocols, a time lag (or delay) may be occurred at a switch timing depending on a method of buffering transmission data in the transmitter.

### SUMMARY

A communication method according to one aspect may be a communication method that performs communication using any one of a first protocol and a second protocol. The method may include performing, before detecting a protocol switch trigger, a redundant writing of transmission data of the first protocol into a transmission buffer for the first protocol. The transmission data may be the same as transmission data of the second protocol. The method may further include performing, upon detecting the protocol switch trigger, a protocol switch from the second protocol to the first protocol.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a communication system to which a WAN optimizer is applied;

FIG. 2 is a conceptual diagram schematically illustrating an exemplary operation when a working system (e.g. TCP) and a protection system (e.g. UDP) in a communication system illustrated in FIG. 1 are switched;

FIG. 3 is a conceptual diagram schematically illustrating an improvement example of the exemplary operation illustrated in FIG. 2;

FIG. 4 is a block diagram illustrating an exemplary configuration of the communication system according to a first embodiment;

FIG. 5 is a block diagram illustrating an exemplary configuration of a wireless terminal (WO #1) illustrated in FIG. 4;

FIG. 6 is a block diagram illustrating an exemplary configuration of the wireless terminal (WO #1) focusing upon a virtual socket processor, a transmission processor, a controller and a protocol designation table illustrated in FIG. 5;

FIG. 7 is a block diagram illustrating an exemplary configuration of a wireless base station (WO #2) illustrated in FIG. 4;

FIG. 8 is a diagram for explaining an outline of an exemplary operation focusing upon quality measurement between the transmission side WO #1 and the reception side WO #2 in an upstream in the communication system illustrated in FIG. 4;

FIG. 9 is a block diagram illustrating an exemplary hardware configuration of the wireless terminal (WO #1) and the wireless base station (WO #2) illustrated in FIG. 4;

FIG. 10 is a diagram illustrating an example of a protocol selection table used in the wireless terminal (WO #1) illustrated in FIG. 5;

FIG. 11 is a diagram illustrating an example of the protocol designation table used in the wireless terminal (WO #1) illustrated in FIG. 5;

FIG. 12 is a diagram illustrating an exemplary data packet format of a UDP-based protocol used in the communication system illustrated in FIG. 4;

FIG. 13 is a diagram illustrating an exemplary data packet format of a TCP-based protocol used in the communication system illustrated in FIG. 4;

FIG. 14 is a diagram illustrating an exemplary measurement packet format of the UDP-based protocol used in the communication system illustrated in FIG. 4;

FIG. 15 is a diagram illustrating an exemplary measurement packet format of the TCP-based protocol used in the communication system illustrated in FIG. 4;

FIG. 16 is a diagram illustrating an exemplary format of a negotiation request message used in the communication system illustrated in FIG. 4;

FIG. 17 is a diagram illustrating an exemplary format of a negotiation response message in response to the negotiation request message illustrated in FIG. 16;

FIG. 18 is a diagram illustrating an exemplary format of a measurement result notification message used in the communication system illustrated in FIG. 4;

FIGS. 19 to 21 are sequence diagrams for explaining exemplary operations of the communication system illustrated in FIG. 4;

FIG. 22 is a flowchart for explaining an exemplary operation of a controller of the wireless terminal (WO #1) illustrated in FIGS. 4 to 6 and 8;

FIG. 23 is a block diagram illustrating an exemplary configuration of a communication system according to a second embodiment;

FIG. 24 is a diagram illustrating an exemplary protocol selection table used in a communication system according to a third embodiment;

FIG. 25A is a diagram illustrating a protocol selection table used in a communication system according to a fourth embodiment;

FIG. 25B is a diagram for explaining an exemplary parameter to determine a critical region (CR) in the protocol selection table illustrated in FIG. 25A;

FIG. 26 is a block diagram illustrating an exemplary configuration of a communication system according to a fifth embodiment;

FIG. 27 is a diagram for explaining exemplary configurations and operations of the wireless terminal (WO #1) and the wireless base station (WO #2) in the communication system illustrated in FIG. 26;

FIG. 28 is a diagram illustrating an exemplary format of a keep alive message used in the communication system illustrated in FIGS. 26 and 27;

FIG. 29 is a diagram illustrating an exemplary format of a keep alive response message in response to the keep alive message illustrated in FIG. 28;

FIG. 30 is a conceptual diagram for explaining random parity stream (RPS) protocol communication used in a communication system according to a sixth embodiment;

FIG. 31 is a diagram for explaining exemplary configurations and operations of the wireless terminal (WO #1) and the wireless base station (WO #2) in the communication system according to the sixth embodiment; and

FIG. 32 is a diagram illustrating an exemplary protocol designation table used in the communication system illustrated in FIG. 31.

### DESCRIPTION OF EMBODIMENTS

Embodiments will be described below with reference to the drawings. However, the following embodiments are merely exemplary embodiments, and are not intended to exclude various modifications and an application of techniques, which are not explicitly described below. In addition, components assigned the same reference numerals indicate the identical or same components in the drawings used in the following embodiments unless otherwise noted.

An increase in use of cloud computing together with a spread of a wireless broadband accelerates a use in which a server of a cloud data center is accessed from a mobile wireless terminal. Since the cloud data center is often located overseas or geographically far from an accesspoint, a round-trip time (RTT) for communication tends to be large. Meanwhile, in a wireless network, discard of data and fluctuation of delay tend to be occurred depending on quality of a wireless link. When once a data discard is occurred in TCP communication performed by using a communication path with a large RTT, communication performance (e.g. throughput) tends to be deteriorated.

Hence, in recent years, an improvement of an average throughput between end devices is tried by arranging devices each of which is called a wide area network (WAN) accelerating device or a WAN optimizer (WO) at both ends of communication path in the WAN.

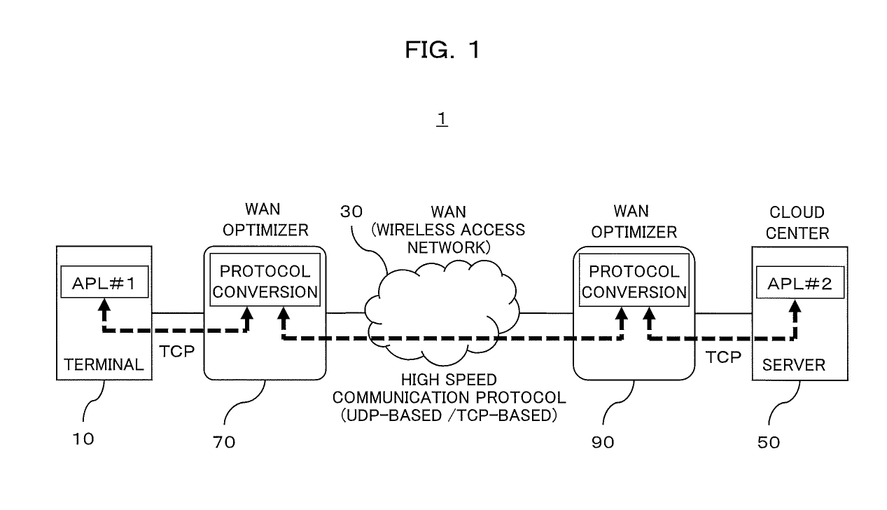

FIG. 1 illustrates an example of a communication system to which a WAN optimizer is applied. A communication system 1 illustrated in FIG. 1 includes, for example, a terminal 10, a WAN 30, a server 50, WAN optimizers 70 and 90 (WO #1 and WO #2). The server 50 may be installed at a cloud center, for example. The WAN 30 may include a wireless access network. Hence, the WAN 30 may be referred to as the wireless access network 30.

The terminal 10 and the server 50 are available to communicate with each other through the WAN optimizers 70 and 90 and the WAN 30. For example, the terminal 10 transmits data generated by an application (APL) #1 and addressed to another application (APL #2) of the server 50 by using a communication protocol (e.g. TCP) suitable for communication with the server 50.

The data transmitted from the terminal 10 is received and terminated at the WAN optimizer 70 and is converted into data of the communication protocol suitable (or optimized) for transmission to the WAN 30. The converted data is then transmitted to the WAN 30. The communication protocol may be, for example, a protocol higher in throughput than an average throughput of TCP communication. Therefore, such higher speed protocol may be referred to as the “high speed communication protocol”. An example of the high speed communication protocol will be described later.

The data transmitted from the WAN optimizer 70 to the WAN 30 by using the high speed communication protocol is received and terminated at the corresponding WAN optimizer 90 and is converted into data of the communication protocol (e.g. TCP) suitable for communication with the server 50. The converted data is then transmitted to the server 50.

The same above would also apply to communication in a reverse direction from the APL of the server 50 to the APL of the terminal 10. For example, the server 50 transmits data generated by the APL #2 and addressed to the APL #1 of the terminal 10 by using a communication protocol (e.g. TCP) suitable for communication with the terminal 10.

The data transmitted from the server 50 is received and terminated at the WAN optimizer 90 and is converted into data of the communication protocol suitable (or optimized) for transmission to the WAN 30. The converted data is then transmitted to the WAN 30.

The data transmitted from the WAN optimizer 90 to the WAN 30 by using the high speed communication protocol is received and terminated at the corresponding WAN optimizer 70 and is converted into data of the communication protocol (e.g. TCP) suitable for communication with the terminal 10. The converted data is then transmitted to the terminal 10.

Thus, the WAN optimizers 70 and 90 terminate a TCP session between the terminal 10 and the server 50, and convert the TCP protocol into the high speed communication protocol to communicate with the corresponding WAN optimizers 90 and 70 by using the high speed communication protocol. The corresponding WAN optimizers 90 and 70 convert the high speed communication protocol back to the original communication protocol and communicate with the server 50 and the terminal 10.

Thereby, it is possible to replace communication congestion control and retransmission control between end devices such as the terminal 10 and the server 50 with congestion control and retransmission control between the WAN optimizers 70 and 90. Accordingly, even when data discard is occurred in the TCP communication, for example, it is possible to prevent a throughput from lowering by controlling congestion or controlling retransmission between the WAN optimizers 70 and 90.

Non-restrictive examples of high speed communication protocols which are applicable to the WAN optimizers 70 and 90 may include a TCP-based communication protocol and a UDP-based communication protocol. The TCP-based high speed communication protocol may be a high speed TCP, for example. The UDP-based high speed communication protocol may be a UDT protocol, for example. The UDT is an abbreviation of a “UDP-based data transfer”. The UDT corresponds to a communication protocol in which congestion control and retransmission control are additionally provided to the UDP.

In a communication line such as a wireless link in which a relatively large delay in time and a data discard are readily occurred, when once a data discard occurred in the communication line, a throughput of the communication line is readily and significantly detonated. In contrast, the UDP-based communication protocol is possible to obtain a higher throughput than that of the TCP-based communication protocol on average.

However, the UDP-based communication protocol has an overhead greater than that of the TCP-based communication protocol. Therefore, when a data discard rate is relatively small, the TCP-based communication protocol is possible to obtain a higher throughput than the UDP-based communication protocol.

Thus, the TCP-based communication protocol and the UDP-based communication protocol differ in a region in which good performance (e.g. throughput) is available according to communication quality. In a wireless link, communication quality is readily changed due to movement of the terminal 10 and an influence such as an interference of other radio waves.

Hence, for example, a path of the UDP-based communication protocol and a path of the TCP-based communication protocol are set in advance between the two WAN optimizers 70 and 90. By selecting a suitable path according to quality of the communication paths and transferring data through the selected path, it is possible to achieve an efficient data transmission.

The following reference document also discloses a technique of dynamically switching between the UDP and the TCP according to communication quality of a network.

Reference document: Junji MAKABE et. al, “A File Transfer Method Dynamically Switching Protocols between TCP and UDP depending on Network Conditions” (IEICE technical report IN 2011-12)

Further, protection techniques such as “1:1 protection” or “1+1 protection” are known as techniques of switching communication paths through which data is transmitted.

According to the “1+1 protection” technique, the same data is transmitted to both of a working path and a protection path. When a switch factor (hereinafter, may be referred to as a “switch trigger”) such as path failure or deterioration in communication quality is detected, a reception end of each path selects and receives data of a path in which the switch trigger is not occurred. Meanwhile, in the “1:1 protection” technique, after a switch trigger is detected, an alternative path is set and enabled.

However, according to the “1+1 protection” technique, since the same data is redundantly transmitted to both of the working and protection paths, a communication band would be wasted. Meanwhile, according to the “1:1 protection” technique, data transmitted during a time period before a path is switched to an alternative path after a switch factor is detected may be discarded.

For example, it may be considered a transmitter that is applied the “1:1 protection” technique and that is available to dynamically switch between a TCP path for the working path and a UDP path for the protection path depending on communication quality.

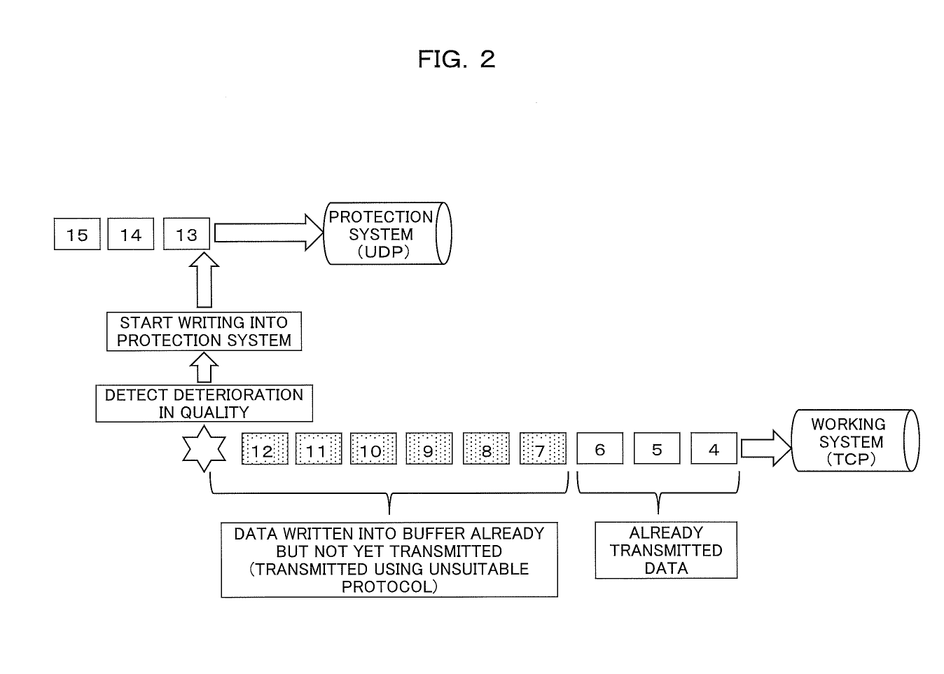

The transmitter may include, for example, transmission buffers corresponding to the TCP (or working path) and the UDP (or protection path), respectively. As schematically illustrated in FIG. 2, the transmitter sequentially writes series of transmission data (#4 to #12) into the transmission buffer for the working path (for the TCP). In FIG. 2, the series of the transmission data #4 to #6 indicate data read from the transmission buffer for the TCP and transmitted already.

Subsequently, when a switch trigger such as deterioration in communication quality using the TCP is detected, the transmitter switches a writing destination of transmission data to be transmitted subsequent to the already transmitted data from the transmission buffer for the TCP to the other transmission buffer for the protection path (UDP). Hence, in FIG. 2, series of transmission data #13 to #15 are written into the transmission buffer for the UDP.

However, the series of the transmission data #7 to #12 that have already been written into the transmission buffer for the TCP but not transmitted yet until a switch trigger is occurred may be transmitted with the TCP even though the switch to the UDP is performed. As a result, the transmission data may be discarded as an unsuitable communication protocol data in the receiver or may be transmitted inefficiently.

By delaying a timing to switch from the TCP to the UDP compared to a timing of detection of the switch trigger, it may be possible to transmit the series of the transmission data #7 to #12 that have not been transmitted yet with the switched UDP.

However, in this case, a time lag is occurred upon a protocol switch, and therefore, effects of the protocol switch would be reduced. For example, if larger transmission buffers are used to improve a throughput as a transmission distance between the transmitter and the receiver is longer and delay is larger, delay of a protocol switch timing would become larger.

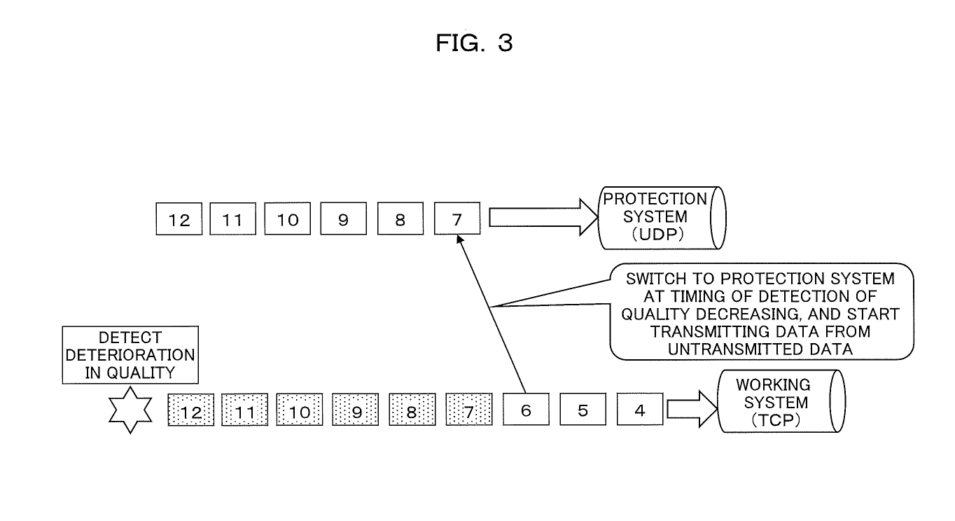

Hence, the present embodiment makes possible to transmit, as exemplarily illustrated in FIG. 3, the series of the transmission data #7 to #12 not having been transmitted yet with the working path by using the protection path at a timing when a switch trigger such as deterioration in communication quality is detected.

### First Embodiment

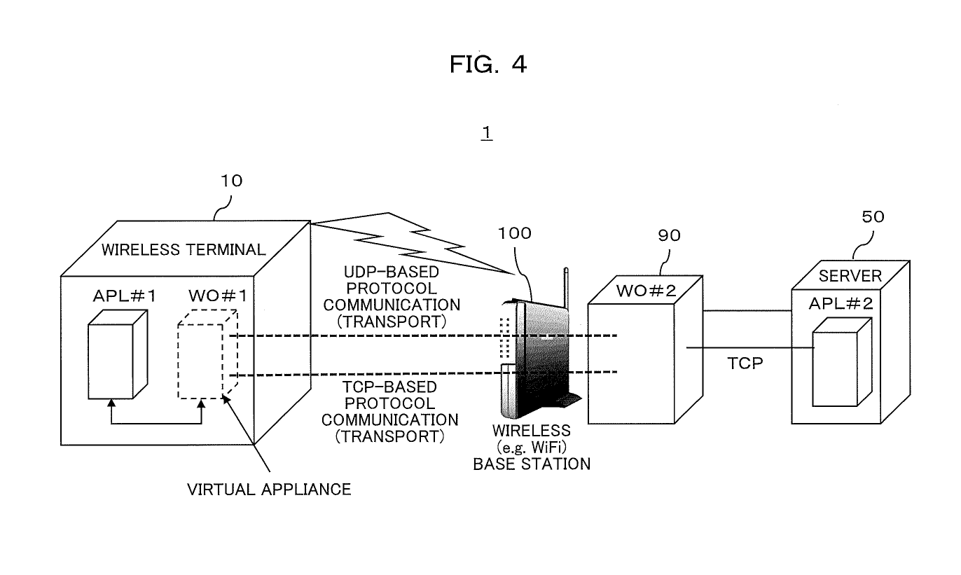

FIG. 4 is a block diagram illustrating a exemplary configuration of a communication system 1 according to a first embodiment. The communication system 1 illustrated in FIG. 4 includes, for example, a wireless terminal 10 that is an example of the terminal 10 illustrated in FIG. 1, a server 50 and a WAN optimizer 90 (WO #2) illustrated in FIG. 1, and a wireless base station 100.

In FIG. 4, a WAN optimizer 70 (WO #1) illustrated in FIG. 1 is installed in the wireless terminal 10. For example, the WO #1 may be installed on an operating system (OS) or a platform of the wireless terminal 10 as a virtual (or logical) appliance provided (or achieved) by a program (which may also be referred to as “software”).

However, the WO #1 may be provided as a physical appliance attached (externally) to the wireless terminal 10. The same would also apply to the WO #2, with making reasonable efforts (and without making any inventive efforts) by those skills in the art. For example, the WO #2 may be provided as a physical appliance attached to or built in the wireless base station 100, or may be installed on an OS or a platform of the wireless base station 100 as a virtual appliance provided (or achieved) by software.

The server 50, the WAN optimizer 90 and the wireless base station 100 may be communicably connected through cables, and the wireless terminal 10 may wirelessly connect to (or communicate with) the wireless base station 100. A non-restrictive example of the wireless base station 100 is a base station that is available in WiFi communication. The wireless base station 100 may also be referred to as an access point (AP). Hereinafter, the wireless base station 100 may also be referred to as the “WiFi base station 100”.

A path of a UDP-based high speed communication protocol and a path of a TCP-based high speed communication protocol are available to be set between the WO #1 and the WO #2. Communication using the TCP is available between an APL #1 of the wireless terminal 10 and the WO #1 and between an APL #2 of the server 50 and the WO #2. Hereinafter, the UDP-based high speed communication protocol may be referred to as a “UDP-based protocol” and the TCP-based high speed communication protocol may be referred to as a “TCP-based protocol”.

(Exemplary Configuration of Wireless Terminal)

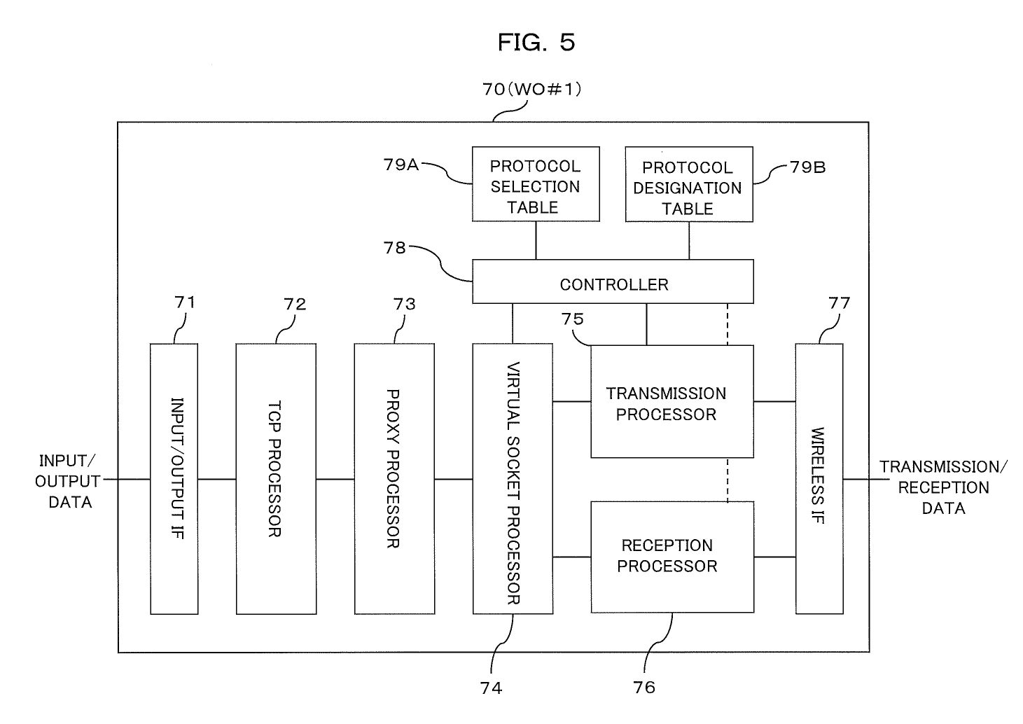

FIG. 5 is a block diagram illustrating an exemplary configuration focusing upon the WAN optimizer 70 (WO #1) of the wireless terminal 10 illustrated in FIG. 4. The wireless terminal 10 (WO #1) illustrated in FIG. 5 include, for example, an input and output interface (IF) 71, a TCP processor 72, a proxy processor 73, a virtual socket processor 74, a transmission processor 75, a reception processor 76 and a wireless IF 77. Further, the WO #1 include a controller 78, a protocol selection table 79A and a protocol designation table 79B, for example.

The input and output IF 71 is an exemplary interface for the APL and is available to transmit transmission data generated by the APL to the TCP processor 72. Further, the input and output IF 71 is available to transmit data received from the TCP processor 72 and addressed to the APL #1, to the APL #1.

The TCP processor 72 is available to convert the data received from the IF 71 into TCP packet data (hereinafter, may also be referred to a “TCP packet”, a “transmission packet” or simply a “packet”) to transmit the converted TCP packet data to the proxy processor 73. Further, the TCP processor 72 is available to convert the TCP packets received from the proxy processor 73 into received data to transmit the received data to the IF 71.

The proxy processor 73 is available to set a proxy to the TCP packets received from the TCP processor 72 as necessary and to transmit the TCP packets to the virtual socket processor 74. Further, upon receiving a TCP packet of a synchronization (SYN) packet, the proxy processor 73 is operable to request the virtual socket processor 74 to create a socket. Furthermore, the proxy processor 73 is available to transmit the TCP packet received from the virtual socket processor 74 to the TCP processor 72.

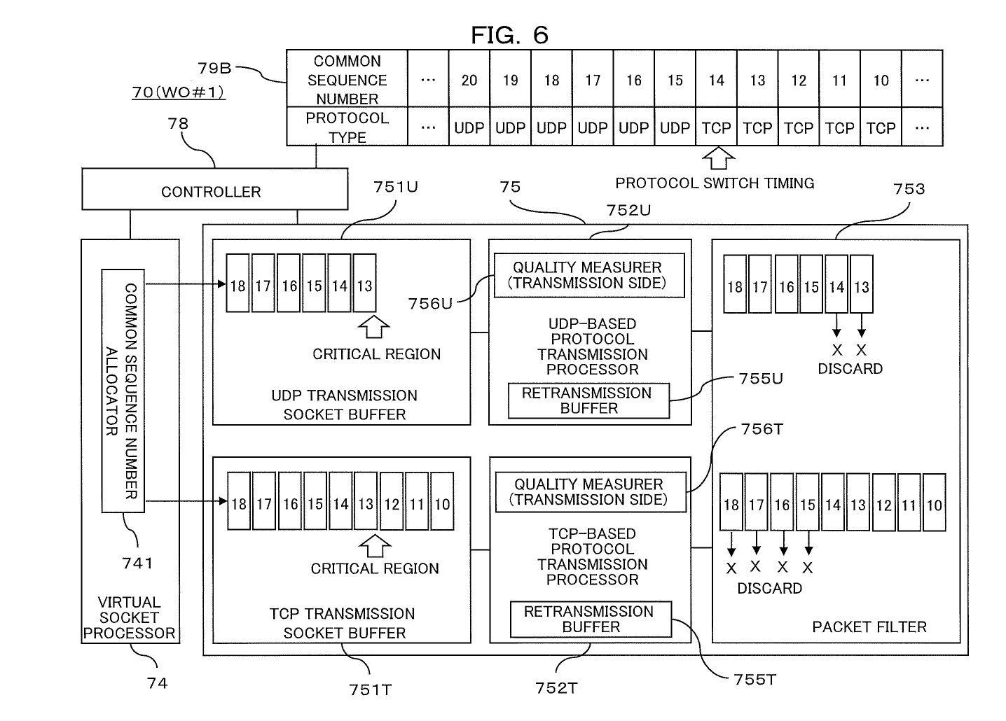

The virtual socket processor 74 is available to provide a socket application programming interface (socket API) for the proxy processor 73 or the APL #1. Further, the virtual socket processor 74 is available to allocate (or assign) common sequence numbers to packets received from the proxy processor 73 according to an instruction from the controller 78. A packet with the assigned common sequence number is written into one of socket buffers 751U and 751T provided in the transmission processor 75 as illustrated in FIG. 6.

The common sequence number is, for example, a sequence number which is independent to a difference in protocols such as the UDP-based protocol and the TCP-based protocol, and is allocated to a packet by a common sequence number allocator 741 illustrated in FIG. 6. Data may be written into each of the transmission socket buffers 751U and 751T in units of segments partitioned by common sequence numbers.

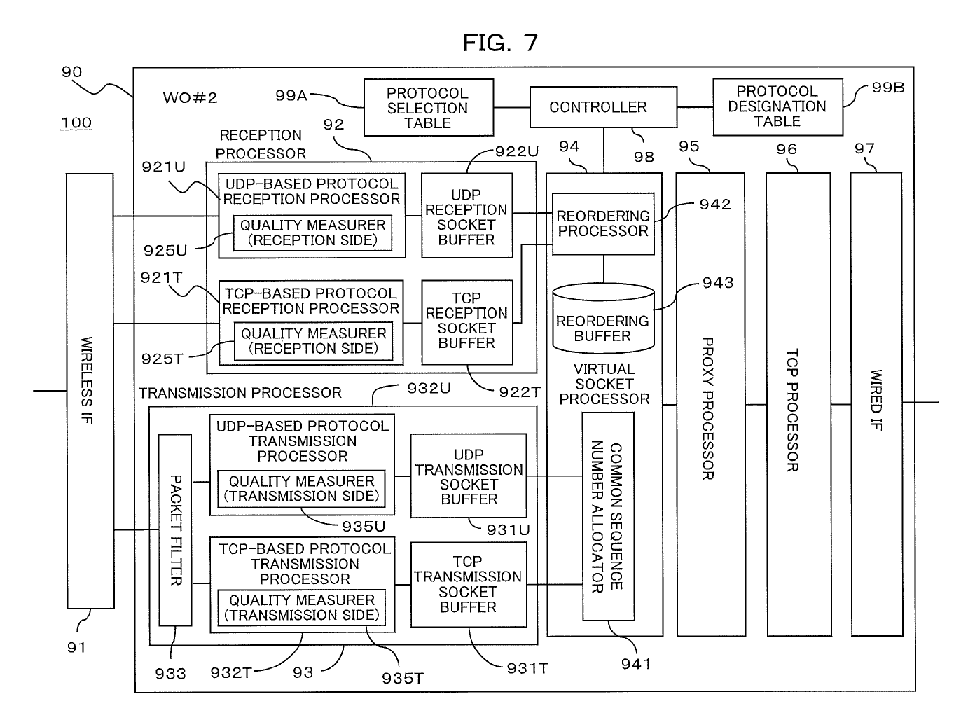

Further, the virtual socket processor 74 is also available to transmit packets received from the reception processor 76 to the proxy processor 73. An exemplary configuration of the reception processor 76 may be the same as that of a reception processor 92 of the WO #2 described below with reference to FIG. 7.

The transmission processor 75 is available to convert the transmission data received from the virtual socket processor 74 into a packet of one of the UDP-based protocol and the TCP-based protocol to transmit the converted packet to a WAN 30 through the wireless IF 77.

As illustrated in FIG. 6, the transmission processor 75 includes, for example, the UDP transmission socket buffer 751U, the TCP transmission socket buffer 751T, a UDP-based protocol transmission processor 752U, a TCP-based protocol transmission processor 752T, and a packet filter 753.

The UDP transmission socket buffer 751U is available to temporarily buffer packets to be transmitted using the UDP-based protocol. The UDP packet-buffering makes possible to absorb a difference between a data transmission rate of the UDP-based protocol transmission processor 752U and a writing rate into the UDP transmission socket buffer 751U by the virtual socket processor 74.

The TCP transmission socket buffer 751T is available to temporarily buffer TCP packets to be transmitted using the TCP-based protocol. The TCP packet-buffering makes possible to absorb a difference between a data transmission rate of the TCP-based protocol transmission processor 752T and a writing rate into the TCP transmission socket buffer 751T by the virtual socket processor 74.

The UDP-based protocol transmission processor 752U is an example of a processor available to transmit packets written into the UDP transmission socket buffer 751U at a predetermined rate supported by the UDP-based protocol. Further, the UDP-based protocol transmission processor 752U may include a retransmission buffer 755U and is available to temporarily accumulates (or holds) packets in the retransmission buffer 755U until an acknowledge response (ACK or NACK) with respect to the transmitted packets is received. For example, when an ACK is received, the accumulated packet corresponding to the ACK in the retransmission buffer 755U may be discarded. In contrast, when a NACK is received, the accumulated packet corresponding to the NACK in the retransmission buffer 755U is transmitted again (or retransmitted).

Furthermore, the UDP-based protocol transmission processor 752U may include, for example, a quality measurer 756U. The quality measurer 756U is available to measure communication quality of the WAN 30 by transmitting measurement packets described later using the UDP-based protocol or by adjusting (or changing) data packet transmission intervals.

A non-restrictive example of the “communication quality” may be a data discard rate, a round-trip time (RTT) or a bandwidth in communication with the communication target of WO #2 (or WAN 30). Further, the quality measurer 756U is available to receive a measurement result of a reception side quality measurer 925U described later with reference to FIG. 7 through the controller 78, for example.

The TCP-based protocol transmission processor 752T is an example of a processor available to transmit packets written into the TCP transmission socket buffer 751T at a predetermined rate supported by the TCP-based protocol. Further, the TCP-based protocol transmission processor 752T may include a retransmission buffer 755T and is available to temporarily accumulate packets in the retransmission buffer 755T until an acknowledge response (ACK or NACK) with respect to the transmitted packets is received. For example, when an ACK is received, the accumulated packets corresponding to the ACK in the retransmission buffer 755T may be discarded. In contrast, when a NACK is received, the accumulated packets corresponding to the NACK in the retransmission buffer 755T is transmitted again (or retransmitted).

Furthermore, the TCP-based protocol transmission processor 752T may include a quality measurer 756T. The quality measurer 756T is available to measure communication quality of the WAN 30 by transmitting measurement packets described later using the TCP-based protocol or by adjusting (or changing) data packet transmission intervals. Further, the quality measurer 756T is available to receive a measurement result of a reception side quality measurer 925T described later with reference to FIG. 7 through the controller 78, for example.

The packet filter 753 is available to filter packets with reference to the protocol designation table 79B based on common sequence numbers allocated to the packets received from each of the protocol transmission processors 752U and 752T. For example, the packet filter 753 allows transmission packets of protocols associated with common sequence numbers to pass but discards transmission packets of protocols not being associated with the common sequence numbers.

In other words, the packet filter 753 is operable to filter packets not being designated (or selected) by the protocol designation table 79B. The packet filter 753 may instruct the protocol transmission processor 752U or 752T that has transmitted the filtered (or discarded) packets to cancel retransmission of the packets accumulated in the retransmission buffers 755U or 755T.

The wireless IF 77 illustrated in FIG. 5 is an example of an IF that enables wireless communication with the wireless base station 100 and is available to wirelessly transmit transmission packets passed through the packet filter 753 to the wireless base station 100.

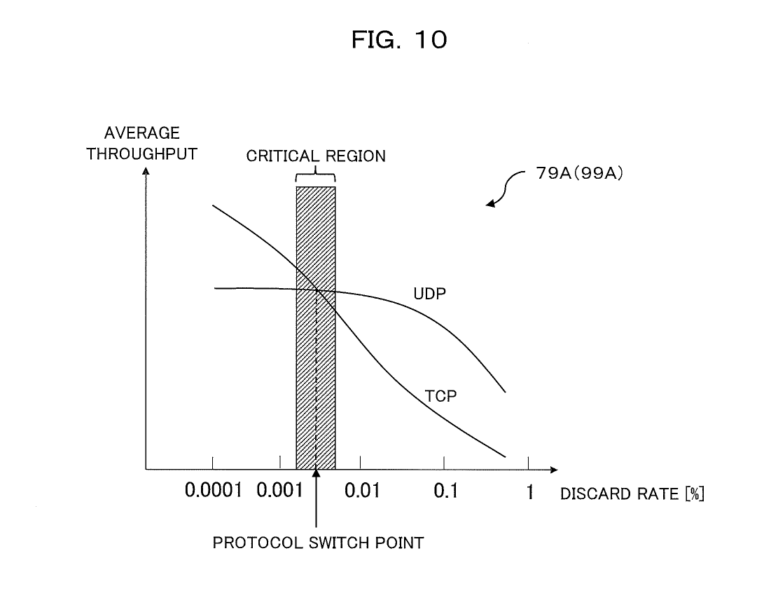

The protocol selection table 79A is an example of control data used to determine a protocol available to achieve higher performance (e.g. an average throughput) based on information (or parameter) that is an indicator of communication quality such as a data discard rate or a RTT. The control data may include, for example, data which enables to determine a vicinity (may also be referred to as a “critical region (CR)”) of a point at which a protocol is switched. The CR is an example of a predetermined communication quality range including a point indicative of communication quality that is a factor causing a protocol switch trigger. The contents of the protocol selection table 79A will be described later in detail with reference to FIG. 10.

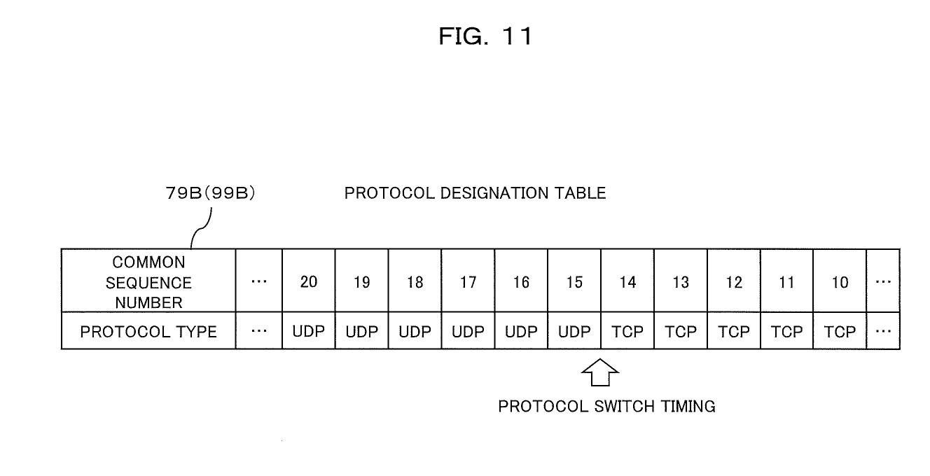

As illustrated in FIG. 11, the protocol designation table 79B is an example of control data of an association indicative of which one of the UDP-based and TCP-based protocols is used to transmit packets having common sequence numbers allocated by the common sequence number allocator 741. The protocol designation table 79B may be set by the controller 78 and is referred to by the packet filter 753 as described above.

The controller 78 is available to receive measurement results from the quality measurers 756U and 756T and to determine a protocol suitable for communication quality at each timing of the measurement results with reference to the protocol selection table 79A based on the measurement results. Further, the controller 78 is also available to set (or register) an association (or a correspondence relation) indicative of which one of the UDP-based and TCP-based protocol is used to transmit the packets having the common sequence numbers allocated by the common sequence number allocator 741 in the protocol designation table 79B.

As a non-restrictive example, in FIG. 11, packets #10 to #14 allocated the common sequence numbers #10 to #14 to be transmitted using the TCP-based protocol and packets #15 to #20 to be transmitted using the UDP-based protocol are designated in the protocol designation table 79B.

Packet #i (i is a natural number) represents a packet allocated a common sequence number “i”. In other words, it may be considered that in the protocol designation table 79B illustrated in FIG. 11, a boundary between the sequence numbers #14 and #15 corresponds to a timing detected a protocol switch trigger in the controller 78. In the present embodiment, the UDP-based and TCP-based protocols are available to be switched at this timing. This timing may also be referred to as a “protocol switch timing”.

Further, upon determining that communication quality falls within the critical region (CR) set to the protocol selection table 79A illustrated in FIG. 10, the controller 78 may instruct the virtual socket processor 74 to perform a redundant writing. For example, the controller 78 is available to instruct the virtual socket processor 74 to write packets in the transmission socket buffers 751U and 751T corresponding to a switch candidate protocol, respectively.

For example, FIG. 6 schematically illustrates a case where the controller 78 determines that communication quality falls within the CR and the virtual socket processor 74 writes the packets #13 to #18 into both of the socket buffers 751U and 751T redundantly according to the instruction of the controller 78.

Hence, the packets #13 to #18 written into both of the transmission socket buffers 751U and 751T are processed by the UDP-based protocol transmission processor 752U and the TCP based-protocol transmission processor 752T, respectively and are inputted to the packet filter 753.

Further, the packet filter 753 filters the packets #13 to #18 inputted from the protocol transmission processors 752U and 752T according to the protocol designation table 79B. As illustrated in the protocol designation table 79B of FIG. 11, it is assumed that the packets #10 to #14 to be transmitted by using the TCP-based protocol and the packets #15 to #20 to be transmitted by using the UDP-based protocol are designated by the controller 78.

In this case, the packet filter 753 allows the packets #13 and #14 among the packets #13 to #18 inputted from the TCP-based protocol transmission processor 752T to be passed to the wireless IF 77 and discards the subsequent packets #15 to #18. Upon discarding the packets #15 to #18, the packet filter 753 may instruct the TCP-based protocol transmission processor 752T to cancel retransmission of the discarded packets #15 to #18.

Further, the packet filter 753 discards the packets #13 and #14 among the packets #13 to #18 inputted from the UDP-based protocol transmission processor 752U and allows the subsequent packets #15 to #18 to be passed to the wireless IF 77. Upon discarding the packets #13 and #14, the packet filter 753 may instruct the UDP-based protocol transmission processor 752U to cancel retransmission of the discarded packets #13 and #14.

Consequently, the wireless terminal 10 (WO #1) is possible to switch a protocol at a timing when a protocol switch trigger is detected (in other words, with a minimum time lag) and to appropriately transmit packets by using the protocol after switched.

(Exemplary Configuration of Wireless Base Station)

FIG. 7 illustrates an exemplary configuration of the wireless base station 100 installed in the WAN optimizer 90 (WO #2). The wireless base station 100 illustrated in FIG. 7 includes, for example, a wireless IF 91 that enables wireless communication with the wireless terminal 10, and the WAN optimizer 90 (WO #2).

The WO #2 includes, for example, the reception processor 92, a transmission processor 93, a virtual socket processor 94, a proxy processor 95, a TCP processor 96, a wired IF 97, a controller 98, a protocol selection table 99A, and a protocol designation table 99B.

The reception processor 92 is available to perform, for example, a reception process on packets received from the wireless terminal 10 (WO #1) through the wireless IF 91. The reception process may include, for example, a reception process according to one or both of the UDP-based protocol and a reception process according to the TCP-based protocol.

Hence, the reception processor 92 illustrated in FIG. 7 may include, for example, a UDP-based protocol reception processor 921U, a TCP-based protocol reception processor 921T, a UDP reception socket buffer 922U, and a TCP reception socket buffer 922T.

The UDP-based protocol reception processor 921U is available to perform a reception process on packets of the UDP-based protocol received from the wireless IF 91 and to write the normally received packets into the UDP reception socket buffer 922U. The writing of the packets may be performed in units of segments partitioned by the common sequence numbers.

Packets that are not received normally may be discarded in the UDP-based protocol reception processor 921U. The UDP-based protocol reception processor 921U is available to notify whether or not packets are discarded to the UDP-based protocol transmission processor 752U of the wireless terminal 10 that is a received packet transmission source by using, for example, an acknowledge response packet, and is available to request retransmission of the discarded packets.

The TCP-based protocol reception processor 921T is available to perform a reception process on packets of the TCP-based protocol received from the wireless IF 91 and to write normally received packets into the TCP reception socket buffer 922T. The writing of the packets may be performed in units of segments partitioned by the common sequence numbers.

Packets that are not received normally may be discarded in the TCP-based protocol reception processor 921T. The TCP-based protocol reception processor 921T is available to notify whether or not packets are discarded to the TCP-based protocol transmission processor 752T of the wireless terminal 10 that is a received packet transmission source by using, for example, an acknowledge response packet, and is available to request retransmission of the discarded packets.

The above protocol reception processors 921U and 921T may include, for example, the quality measurers 925U and 925T, respectively.

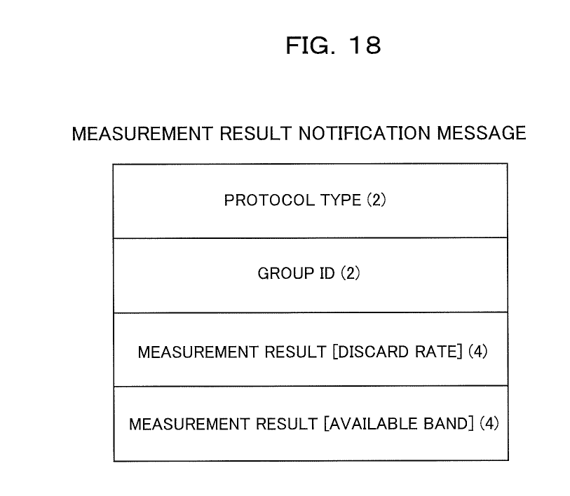

The quality measurers 925U and 925T are available to monitor measurement packets transmitted by the quality measurers 756U and 756T (see FIG. 6) of the wireless terminal 10 that is an transmission source or data packets whose packet transmission intervals are adjusted in the wireless terminal 10 to thereby measure communication quality of a network. The measurement results are notified to the quality measurers 132U and 132T of the wireless terminal 10 that is the transmission source of the received packet. The notifications of measurement results may be performed by the controller 98 and the transmission processor 93. For example, a measurement result notification message described later with reference to FIG. 18 is applicable to the notification of the measurement result.

The UDP reception socket buffer 922U may be provided for the UDP-based protocol reception processor 921U and is available to temporarily buffer packets received by the UDP-based protocol reception processor 921U. The UDP packet-buffering makes possible to absorb a difference between a data reception rate of the UDP-based protocol reception processor 921U and a read rate by the proxy processor 95 through the virtual socket processor 94.

The TCP reception socket buffer 922T may be provided for the TCP-based protocol reception processor 921T and is available to temporarily buffer packets received by the TCP-based protocol reception processor 921T. The TCP packet-buffering makes possible to absorb a difference between a data reception rate of the TCP-based protocol reception processor 921T and a read rate by the proxy processor 95 through the virtual socket processor 94.

The same function as that of the reception processor 92 of the WO #2 may be provided as an example of the reception processor 76 of the wireless terminal 10 (WO #1) illustrated in FIG. 5.

In other words, the wireless terminal 10 (WO #1) may be provided with the same function as that of the reception processor 92 available to perform communication in an upstream from the wireless terminal 10 to the server 50, as a reception processor 76 available to perform communication in a downstream opposite to the upstream. The “downstream” and the “upstream” may be referred to as the “downlink” and the “uplink”, respectively.

In contrast, the transmission processor 93 available to perform communication in the downstream in the wireless base station 100 (WO #2) illustrated in FIG. 7 may have the same function as that of the transmission processor 75 available to perform communication in the upstream in the wireless terminal 10 illustrated in FIG. 6.

For example, the transmission processor 93 illustrated in FIG. 7 is available to transmit data received from the virtual socket processor 94 and addressed to the wireless terminal 10 through the wireless IF 91 with packets of one of the UDP-based protocol and the TCP-based protocol.

Hence, similar to the transmission processor 75 of the wireless terminal 10, the transmission processor 93 may include, for example, a UDP transmission socket buffer 922U and a TCP transmission socket buffer 922T. Further, the transmission processor 93 may include, for example, UDP-based and TCP-based protocol transmission processors 932U and 932T, and a packet filter 933.

The UDP transmission socket buffer 931U may be provided for the UDP-based protocol and is available to temporarily buffer packets to be transmitted using the UDP-based protocol. The UDP packet-buffering makes possible to absorb a difference between a data transmission rate of the UDP-based protocol transmission processor 932U and a write rate into the UDP transmission socket buffer 931U by the virtual socket processor 94.

The TCP transmission socket buffer 931T may be provided for the TCP-based protocol and is available to temporarily buffer TCP packets to be transmitted using the TCP-based protocol. The TCP packet-buffering makes possible to absorb a difference between a data transmission rate of the TCP-based protocol transmission processor 932T and a write rate into the TCP transmission socket buffer 931T by the virtual socket processor 94.

The UDP-based protocol transmission processor 932U may provide the same function as that of the UDP-based protocol transmission processor 752U (see FIG. 6) in the wireless terminal 10. For example, the UDP-based protocol transmission processor 932U is an example of a processor available to transmit packets written into the UDP transmission socket buffer 931U at a predetermined rate supported by the UDP-based protocol.

Although not illustrated in FIG. 7, the UDP-based protocol transmission processor 932U may be provided with the same retransmission buffer as the retransmission buffer 755U provided in the UDP-based protocol transmission processor 752U in the wireless terminal 10. The UDP-based protocol transmission processor 932U is available to temporarily store (or accumulate or cache) packets in the retransmission buffer until an acknowledge response (ACK or NACK) with respect to the transmitted packets are received. For example, when an ACK is received, the packet corresponding to the ACK in the retransmission buffer may be discarded (or deleted). Meanwhile, when a NACK is received, the packet corresponding to the NACK in the retransmission buffer may be transmitted again (or retransmitted).

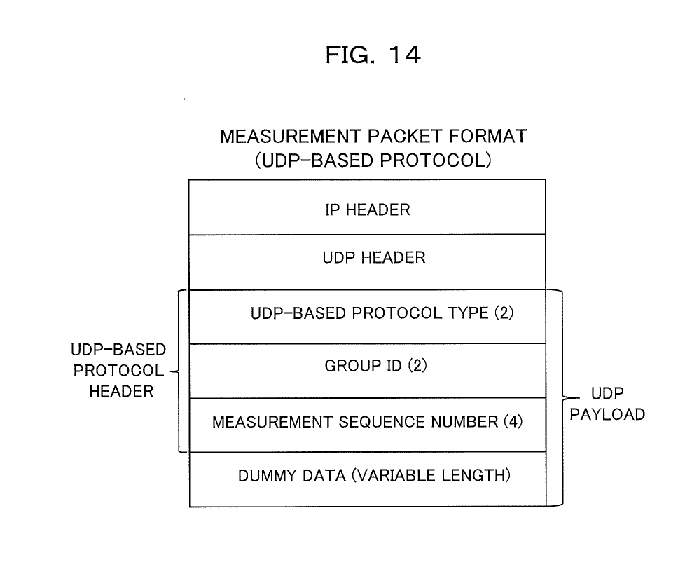

Further, the UDP-based protocol transmission processor 932U may include, for example, the quality measurer 935U. The quality measurer 935U is available to measure communication quality of the WAN 30 by transmitting measurement packets described later with reference to FIG. 14 or by adjusting (or changing) transmission intervals of data packets, with use of the UDP-based protocol.

A non-restrictive example of the “communication quality” may be a data discard rate, a round-trip time (RTT) or a bandwidth in communication with the wireless terminal 10 (communication target WO #1) (WAN 30). The quality measurer 935U is available to receive a measurement result of the reception side quality measurer (not illustrated in FIG. 5), which is provided in the reception processor 76 of the wireless terminal 10 for the UDP-based protocol in the downstream, through the controller 98, for example.

The TCP-based protocol transmission processor 932T is an example of the processor available to transmit packets written into the TCP transmission socket buffer 931T at a predetermined rate supported by the TCP-based protocol. Further, the TCP-based protocol transmission processor 932T may be provided with the same retransmission buffer as the retransmission buffer 755T provided in the TCP-based protocol transmission processor 752T of the wireless terminal 10.

The TCP-based protocol transmission processor 932T is available to temporarily accumulate packets in the retransmission buffer until an acknowledge response (ACK or NACK) with respect to the transmitted packets is received. For example, when the ACK is received, the packet corresponding to the ACK in the retransmission buffer may be discarded. Meanwhile, when the NACK is received, the packet corresponding to the NACK in the retransmission buffer may be transmitted again (or retransmitted).

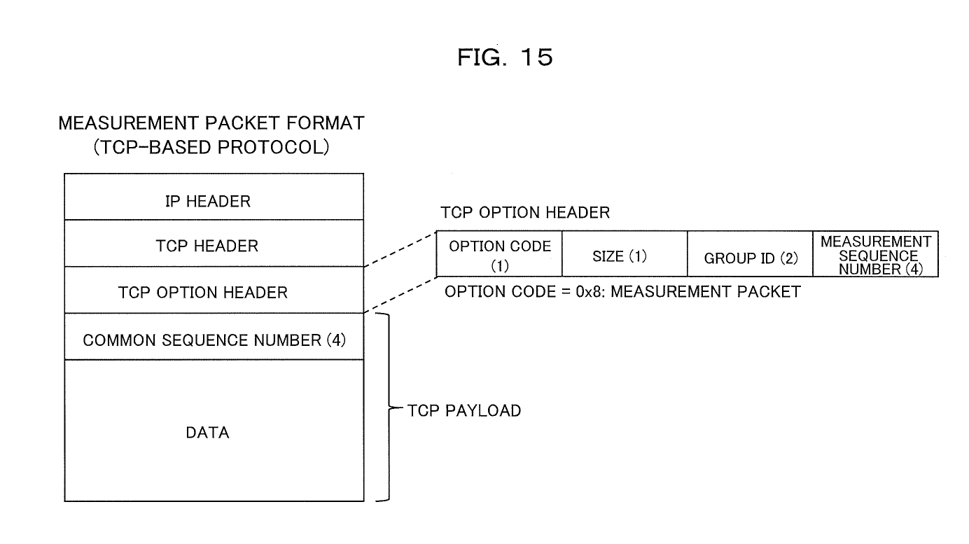

Further, the TCP-based protocol transmission processor 932T may be provided with a quality measurer 935T, for example. The quality measurer 935T is available to measure communication quality of the WAN 30 by transmitting measurement packets described later with reference to FIG. 15 or by adjusting (changing) transmission intervals of data packets, with use of the TCP-based protocol. Furthermore, the quality measurer 935T is available to receive a measurement result of a reception side quality measurer (not illustrated in FIG. 5), which is provided in the reception processor 76 of the wireless terminal 10 for the TCP-based protocol in the downstream, through the controller 98, for example.

The packet filter 933 may provide the same function as that of the packet filter 753 in the wireless terminal 10. For example, the packet filter 933 is available to filter packets with reference to the protocol designation table 99B based on the common sequence numbers allocated to the transmission packets received from the protocol transmission processors 932U and 932T.

The packet filter 933 allows transmission packets of a protocol associated with the common sequence numbers to be passed but discards transmission packets of a protocol not being associated with command sequence numbers. Upon discarding the packets, the packet filter 933 may instruct the protocol transmission processor 932U or 932T that is a source of the discarded packets to cancel retransmission of packets accumulated in the retransmission buffer.

The virtual socket processor 94 is available to provide a socket API to the proxy processor 95. Further, the virtual socket processor 94 is available to control ordering of received packets or to allocate common sequence numbers to transmission packets addressed to the wireless terminal 10 according to an instruction of the controller 98.

Hence, the virtual socket processor 94 illustrated in FIG. 6 may include, for example, a common sequence number allocator 941, a reordering processor 942, and a reordering buffer 943.

The common sequence number allocator 941 may have the same function as that of the common sequence number allocator 741 in the wireless terminal 10. For example, the common sequence number allocator 941 is available to allocate common sequence numbers to packets received from the proxy processor 95 according to the instruction of the controller 98. The packets with the allocated common sequence numbers are written into one of the transmission socket buffers 931U and 931T in the transmission processor 93.

The reordering processor 942 is available to reorder an order of packets in correct order based on the common sequence numbers allocated to the received packets when an order of packets received through paths of the UDP-based and TCP-based protocols is changed from the transmission order. Hence, the packets read from the reception socket buffers 922U and 922T to the reordering processor 942 may be temporarily held in the reordering buffer 943, for example.

Although not illustrated in FIG. 5, the same functions as those of the reordering processor 942 and the reordering buffer 943 for the upstream may be provided to the virtual socket processor 74 of the wireless terminal 10 (WO #1). In other words, the wireless terminal 10 (WO #1) may control the order of the received packets in the downstream based on the common sequence numbers.

The proxy processor 95 is available to set a proxy to TCP packets received from the TCP processor 96 as necessary and to transmit the TCP packets to the virtual socket processor 94. Further, upon receiving a TCP packet of a synchronization (SYN) packet, the proxy processor 95 is available to request the virtual socket processor 94 to create a socket. Furthermore, the proxy processor 95 is available to transmit the TCP packets received from the virtual socket processor 94 to the TCP processor 96.

The TCP processor 96 is available to convert data received from the wired IF 97 into packets to thereby transmit the converted packets to the proxy processor 95. Further, the TCP processor 96 is available to convert TCP packets received from the proxy processor 95 into received data to thereby transmit the received data to the wired IF 97.

The wired IF 97 is an example of a communication interface that enables wired communication with the server 50 and that transmits to the server 50 transmission data received from the TCP processor 96 and addressed to the server 50. Further, the wired IF 97 is available to transmit to the TCP processor 96 the data received from the server 50 and addressed to the wireless terminal 10.

The controller 98 may provide the same function as that of the controller 78 (see FIGS. 5 and 6) in the wireless terminal 10 (WO #1). For example, the controller 78 is available to receive measurement results from the quality measurers 935U and 935T and to determine a protocol suitable for communication quality at each timing of the measurement results with reference to the protocol selection table 99A based on the measurement results.

Further, the controller 98 is available to set (or register) an association (or correspondence relation) indicative of which one of the UDP-based and TCP-based protocols is used to transmit a packet having a common sequence number allocated by the common sequence number allocator 941 to the protocol designation table 99B. The protocol designation table 99B may be referred to by the packet filter 933 upon transmitting packets in the downstream, for example.

In a non-restrictive example, the protocol designation table 99B may have the same data format as that of the protocol designation table 79B (see FIGS. 6 and 11) in the WO #1. For example, the packets #12 to #14 allocated the common sequence numbers 12 to 14 to be transmitted using the TCP-based protocol and the packets #15 to #17 to be transmitted using the UDP-based protocol may be designated in the protocol designation table 99B.

Further, upon determining that communication quality measured as described above falls within the critical region (CR) set to the protocol selection table 99A, the controller 98 is available to instruct the virtual socket processor 94 to perform a redundant writing. For example, the controller 98 may instruct the virtual socket processor 94 to write packets into both of the transmission socket buffers 931U and 931T corresponding to switch candidate protocols.

Further, the packet filter 933 of the transmission processor 93 is available to filter packets inputted from the protocol transmission processors 932U and 932T according to the protocol designation table 99B.

Consequently, similar to the upstream, the wireless base station 100 (WO #2) is possible to switch a protocol at a timing of detection of a protocol switch trigger (in other words, with a minimum time lag) in the downstream. Therefore, the WO #2 is possible to appropriately transmit packets to the wireless terminal 10 by using the protocol after switched.

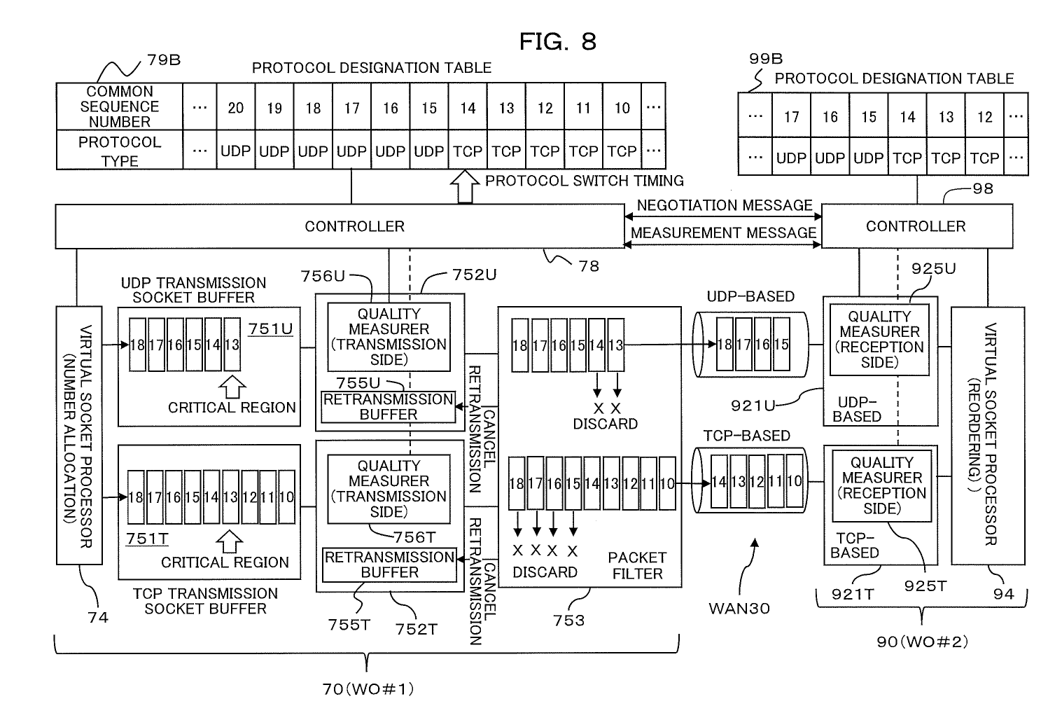

Next, an outline of an operation focusing on quality measurement between the transmission side WO #1 and the reception side WO #2 in the upstream will be described with reference to FIG. 8. In this regard, FIG. 7 illustrates configuration examples of the WO #1 serving as a transmitter and the WO #2 serving as a receiver in the upstream, and configurations in the downstream are omitted in FIG. 7.

The controller 78 of the WO #1 serving as the transmitter is available to periodically instruct the quality measurers 756U and 756T of the protocol transmission processors 752U and 752T to measure communication quality.

Each of the quality measurers 756U and 756T is available to transmit a plurality of measurement packets for each of the UDP-based and TCP-based protocols to the upstream (WO #2).

Each of the quality measurers 925U and 925T, which correspond to the protocol reception processors 921U and 921T in the reception processor 92 of the WO #2 serving as the receiver, is available to receive the measurement packets of each protocol. Each of the quality measurers 925U and 925T is available to measure the number of discarded measurement packets and to calculate a discard rate (hereinafter, may also be referred to as a “packet discard rate”).

The number of measurement packets transmitted using each protocol may be known in the transmission side and the reception side. For example, the controller 78 of the WO #1 and the controller 98 of the WO #2 may exchange a negotiation message each other to notify the number of measurement packets to be transmitted using each protocol one another. Alternatively, the number of measurement packets may be stored as the number known to both of the WO #1 and the WO #2 in a memory or the like.

Further, each of the quality measurers 925U and 925T is available to measure available bands by measuring packet intervals of the received measurement packets and to notify measurement results to the controller 98. The controller 98 is available to notify the notified measurement results to the controller 78 of the WO #1 by using the measurement result notification message illustrated in FIG. 18, for example.

In the WO #1, each of the quality measurers 756U and 756T corresponding to the UDP and TCP protocols is available to measure a time (e.g. RTT) taken from a transmission of data packet until a reception of an acknowledge response transmitted by the WO #2, and is available to notify measurement results to the controller 78.

(Exemplary Hardware Configuration)

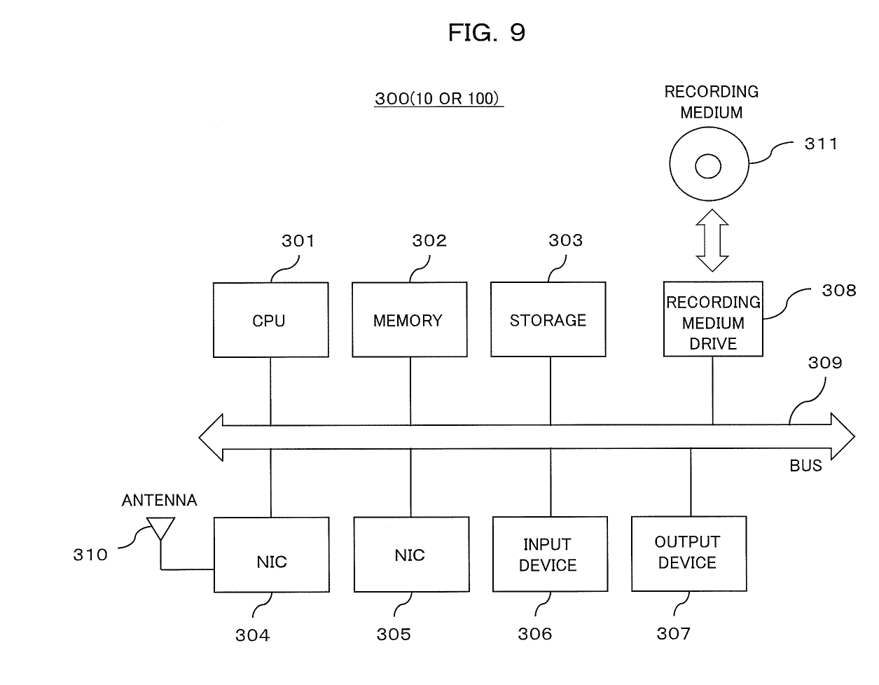

FIG. 9 illustrates exemplary hardware configurations of the above wireless terminal 10 and wireless base station 100. Hereinafter, the wireless terminal 10 and the wireless base station 100 may be collectively referred to as a “wireless device 300” for the sake of convenience. As illustrated in FIG. 9, the wireless device 300 may include a CPU 301, a memory 302, a storage 303, network interface cards (NICs) 304 and 305, and a bus 309. Further, the wireless device 300 may optionally be provided with an input device 306, an output device 307, and a recording medium drive 308.

The CPU 301, the memory 302, the storage 303 and the NICs 304 and 305 are communicably connected through the bus 309 with each other. When any one of the input device 306, the output device 307 and the recording medium drive 308 is installed to the wireless device 300, such installed component may also be connected to the bus 309.

The CPU 301 is an example of a processor with arithmetic operation capability and is available to control an entire operation of the wireless device 300. The processor with arithmetic operation capability may be considered as an example of a computer.

For example, the CPU 301 appropriately reads and executes a program (or software) or data stored in the memory 302 and the storage 303 to achieve (or realize or embody) the functions of the wireless terminal 10 illustrated in FIGS. 5 and 6 and the wireless base station 100 illustrated in FIG. 7.

In other words, the TCP processor 72, the proxy processor 73, the virtual socket processor 74, the transmission processor 75, the reception processor 76 and the controller 78 in the wireless terminal 10 illustrated in FIGS. 5 and 6 may be achieved by processes of the CPU 301.

Further, the reception processor 92, the transmission processor 93, the virtual socket processor 94, the proxy processor 95, the TCP processor 96 and the controller 98 in the wireless base station 100 illustrated in FIG. 7 may also be achieved by processes of the CPU 301.

A program available to cause the CPU 301 to achieve the above-described processes as operations (or functions) of the wireless terminal 10 (WO #1) and the wireless base station 100 (WO #2) may be referred to as a “communication control program (or software)”.

The memory 302 may be, for example, a RAM or a ROM and is available to store the above-mentioned program or data. The data may include data used for a process by the CPU 301 and resultant data of the process performed by the CPU 301. The above-described protocol selection table 79A (or 99A) and protocol designation table 79B (or 99B) may be stored and realized in the memory 302.

Further, the above-described socket buffers 751U, 751T, 922U, 922T, 931U and 931T may be realized as virtual (or logical) buffers in the memory 302. Further, the above-described retransmission buffers 755U and 755T and the reordering buffer 943 may also be realized as virtual (or logical) buffers in the memory 302.

The storage 303 may be, for example, an external storage device such as a hard disk drive (HDD) and is available to store the above-mentioned program and data. For example, the program and the data stored in the storage 303 may be expanded in the memory 32 appropriately according to an instruction of the CPU 301 and may be used for processes performed by the CPU 301.

The NIC 304 is available to provide wireless connection with the wireless base station 100 or the wireless terminal 10 to enable wireless communication with the wireless base station 100 or the wireless terminal 10 through the antenna 310. In other words, the wireless IF 77 of the wireless terminal 10 illustrated in FIG. 5 or the wireless IF 91 of the wireless base station 100 illustrated in FIG. 7 may be realize by the NIC 304.

The NIC 305 is available to provide, for example, wired connection with an external device. For example, the NIC 305 of the wireless base station 100 is available to provide wired connection with the server 50. In other words, the wired IF 97 of the wireless base station 100 illustrated in FIG. 7 may be realized by the NIC 305.

The input device 306 may include, for example, a keyboard, a mouse and a touch panel, and the output device 307 may include a display device (e.g., a display or a touch panel) and a printing device.

The recording medium drive 308 is available to output data of the memory 302 and the storage 303 to a recording medium 311, to read a program and data from the recording medium 311 and to output the program and the data to the storage 303 and the memory 302. Therefore, programs and data available to realize a function of the wireless device 300 may be installed from the recording medium 311.

The recording medium 311 is a non-transitory computer-readable recording medium. The recording medium 311 may be an arbitrary recording medium such as a flexible disk, a magneto-optical (MO) disk, a compact disc recordable (CD-R) or a digital versatile disk recordable (DVD-R). The programs and the data available to realize the function of the wireless device 300 may be downloaded and installed to the wireless device 300 by way of communication from an external device such as the server 50 through the NIC 304 or the NIC 305.

(Example of Protocol Selection Table)

The WO #1 illustrated in FIGS. 5 and 6 may include characteristic data illustrated in FIG. 10 as an example of the protocol selection table 99A. The characteristic data illustrated in FIG. 10 is an example of data indicative of a change in an average throughput with respect to a discard rate (%) upon communication using the UDP-based protocol and communication using the TCP-based protocol.

As can be seen from FIG. 10, there are a region in which the TCP-based protocol is available to achieve an average throughput higher than that of the UDP-based protocol and a region in which this relationship is reversed. A boundary between these two regions may be indicated by a discard rate corresponding to an intersection of each characteristics.

Hence, the controller 78 (or 98) is available to determine a specific range of the discard rates as a critical region (CR) including a point at which the above-described measurement result of communication quality indicates the corresponding discard rate, such that a protocol can be switched at the point (or timing). For example, the critical region may be set to a range expressed by the following equation (1) with respect to the discard rate p (%) of a protocol switch point.

[Equation 1]

CR=p±10^{(log(p)-1)}[%] (1)

Upon detecting that the discard rate p changes from an outside of the CR to the inside of the CR, the controller 78 (or 98) may control the redundant writing of transmission packets into the socket buffers. For example, the controller 78 (or 98) is available to instruct the virtual socket processor 74 (or 94) as described before to redundantly write transmission packets into both of the transmission socket buffers 751U and 751T (or 931U and 931T) of each protocol.

(Packet Format Example)

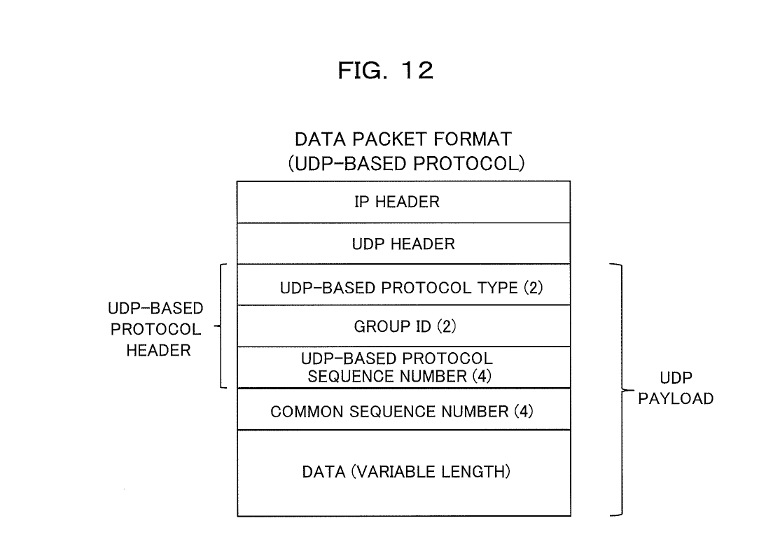

FIGS. 12 to 18 illustrate exemplary formats of packets or messages used in the above-described communication system 1.

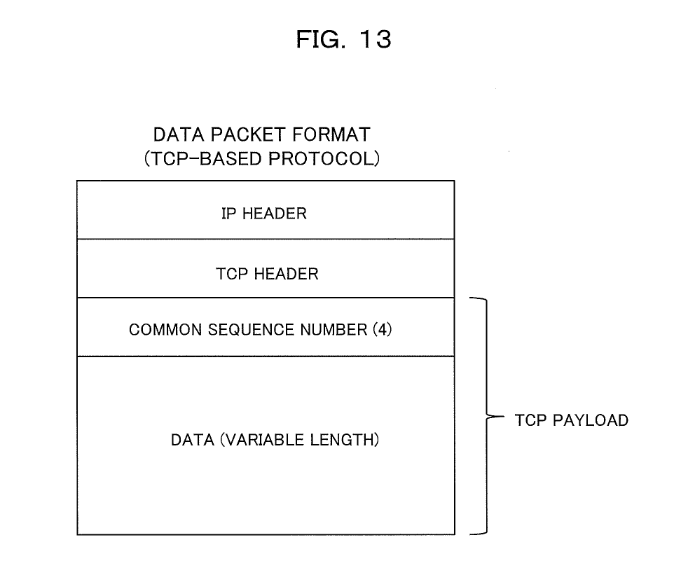

FIG. 12 illustrates an exemplary data packet format of the UDP-based protocol, and FIG. 13 illustrates an exemplary data packet format of the TCP-based protocol. Further, FIG. 14 illustrates an exemplary measurement packet format of the UDP-based protocol, and FIG. 15 illustrates an exemplary measurement packet format of the TCP-based protocol.

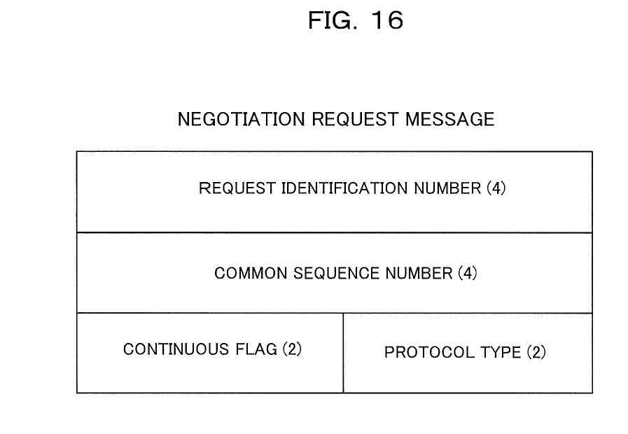

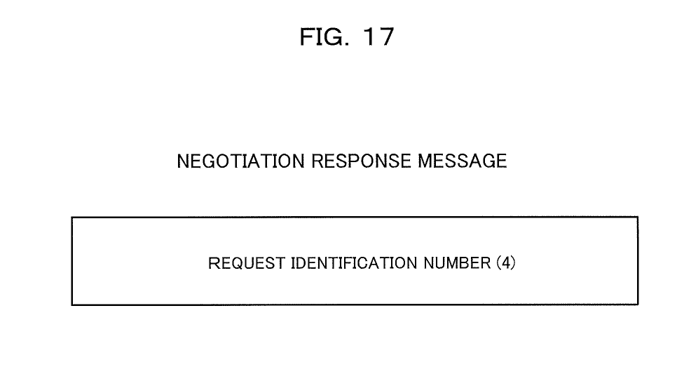

Further, FIGS. 16 and 17 illustrate exemplary formats of negotiation messages. FIG. 16 illustrates an exemplary format of a negotiation request message, and FIG. 17 illustrates an exemplary format of a negotiation response message. Furthermore, FIG. 18 illustrates an exemplary a format of a measurement result notification message used to notify the aforementioned quality measurement result.

As illustrated in FIG. 12, a data packet of the UDP-based protocol may include an IP header, a UDP header, and a UDP payload. The UDP payload may include, for example, a UDP-based protocol header, the aforementioned common sequence number (e.g. four bytes), and data (e.g. variable length data). The UDP-based protocol header may include, for example, an information element (e.g. two bytes) indicative of a type of the UDP-based protocol, a group identifier (ID) (two bytes), and a UDP-based protocol sequence number (four bytes).

The aforementioned quality measurement may be performed by using an available transmission data packet instead of using a measurement packet. In a case where the number of packets to be transmitted for the quality measurement is negotiated in advance between the WO #1 and the WO #2 upon quality measurement, the group identifier may be used to, for example, distinguish the negotiated number of data packets. The same identifier may be set to the packets included in the negotiated number of packets. When packets are repeatedly transmitted in units of the negotiated number of packets, a different value may be set to the group ID field for the repetitive transmission groups (units).

Meanwhile, as illustrated in FIG. 13, a data packet of the TCP-based protocol may include, for example, an IP header, a TCP header and a TCP payload. The TCP payload may include the aforementioned common sequence number (e.g. four bytes) and data (e.g. variable length data).

A common sequence number of the packet format illustrated in FIGS. 12 and 13 is allocated by the common sequence number allocator 741 (or 941).

Further, as illustrated in FIG. 14, a measurement packet of the UDP-based protocol differs from a data packet of the UDP-based protocol illustrated in FIG. 12 in including a measurement sequence number (e.g. four bytes) instead of the UDP-based protocol sequence number. Furthermore, the measurement packet of the UDP-based protocol may include dummy data (e.g. variable length data) as the “data”.

Meanwhile, as illustrated in FIG. 15, the measurement packet of the TCP-based protocol differs from the data packet of the TCP-based protocol illustrated in FIG. 13 in additionally including a TCP option header.

The TCP option header may include, for example, an option code (e.g. one byte), an information element (e.g. one byte) indicative of a size of the TCP option header, a group ID (e.g. two bytes) and a measurement sequence number (e.g. four bytes). The option code may be a code (as a non-restrictive example, 0x8 of a hexadecimal number) indicating that a corresponding packet is a measurement packet.

It is possible to measure the aforementioned packet discard rate and the RTT based on the measurement sequence number in the formats illustrated in FIGS. 14 and 15.

Further, negotiation messages illustrated in FIGS. 16 and 17 may be used for communication (or notification) between the controller 78 and the controller 98 as described above. The negotiation request message illustrated in FIG. 16 may include, for example, a request identification number (e.g. four bytes), the aforementioned common sequence number (e.g. four bytes), a continuous flag (e.g. two bytes), and an information element (e.g. two bytes) indicative of a protocol type.

The request identification number is an example of an information element available to identify a process requested by the message. For example, the controller 78 (or 98) may use the negotiation request message to request a process of transmitting measurement packets.

The continuous flag is an example of an information element indicative of the number of measurement packets to be continuously transmitted.

The information element indicative of a protocol type is, for example, an example of an information element indicative of any one of the UDP-based protocol and the TCP-based protocol.

The controller 78 (or 98) is available to transmit measurement packets whose protocol is designated by the “protocol type” and whose number corresponds to the number designated by the “continuous flag”.

The negotiation response message illustrated in FIG. 17 may be used by the controller 78 (or 98) that has received the negotiation request message illustrated in FIG. 16 to return a response corresponding to the process requested by the request message. The negotiation response message may include, for example, a request identification number (e.g. four bytes) that is an example of an information element available to identify which requests correspond to the response.

Further, as illustrated in FIG. 18, the measurement result notification result may include, for example, an information element (e.g. two bytes) indicative of a protocol type, a group ID (e.g. two bytes), a measurement result (or discard rate) (e.g. four bytes), and a measurement result (or available band) (four bytes). Information indicative of any one of the UDP-based and TCP-based protocol may be set to the information element indicative of the protocol type.

(Operation Example)

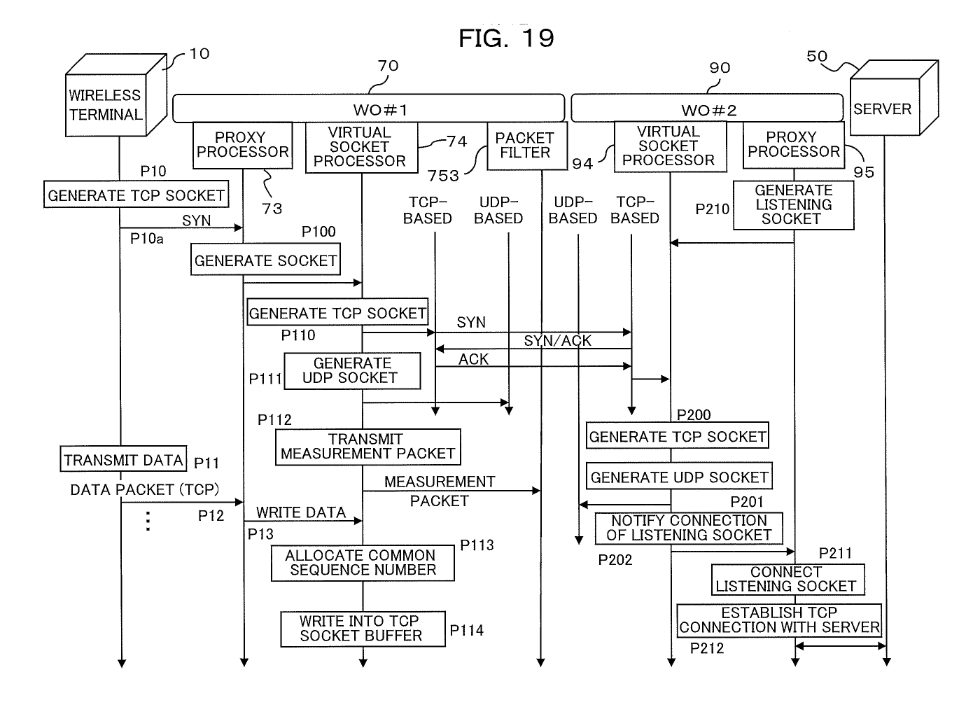

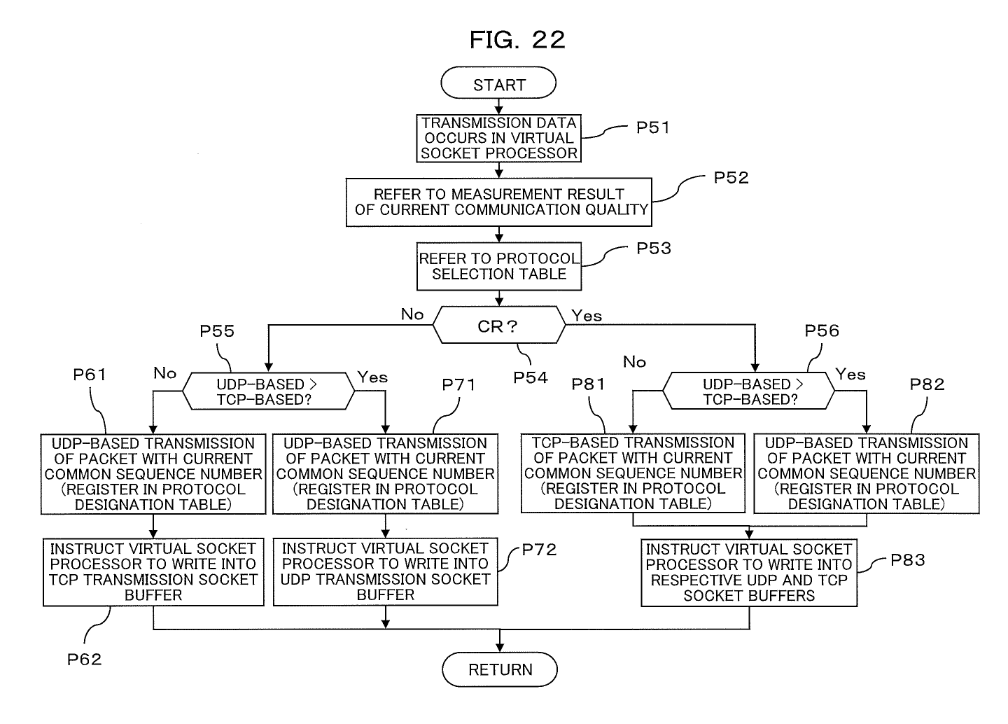

Next, an exemplary operation of the above communication system 1 will be described with reference to FIGS. 19 to 22. FIGS. 19 to 21 illustrate operation sequence examples focusing upon a packet flow in the upstream from the wireless terminal 10 to the server 50. In FIGS. 19 to 21, an acknowledge response related to the TCP communication is omitted. FIG. 22 is a flowchart illustrating an operation example of the controller 78 in the wireless terminal 10 (WO #1) that is a transmission source in the upstream.

First, it is assumed that since a packet discard rate in the wireless access network 30 is lower than that at the protocol switch point illustrated in FIG. 9, the wireless terminal 10 has been communicating with the server 50 using the TCP-based protocol. Thereafter, when the packet discard rate becomes higher than that at the protocol switch point depending on a movement of the wireless terminal 10, the wireless terminal 10 switches the TCP-based protocol to the UDP-based protocol and performs communication using the UDP-based protocol. Hereinafter, the operation example in this case will be described.

(Operation Sequence Example)

As exemplarily illustrated in FIG. 19, in response to a generation of data addressed to the server 50 by the APL #1, the wireless terminal 10 creates a TCP socket for connecting to the server 50 (process P10) and starts setting the connection. The wireless terminal 10 generates a TCP synchronization (SYN) packet in response to the start of the connection setting. The SYN packet is an example of a packet to which a SYN flag is set.

The SYN packet is relayed to the wireless access network 30 by the WO #1. In the WO #1, the SYN packet is transferred to the proxy processor 73 through the IF 71 and the TCP processor 72 (process P10a).

The proxy processor 73 returns a synchronization acknowledgement (SYN/ACK) that is a response to the SYN packet, to the APL #1 of the wireless terminal 10 on the behalf of the server 50, and performs a termination process of the TCP. The SYN/ACK packet is a packet to which a SYN flag and an ACK flag are set.

Upon receiving the SYN/ACK packet, the APL #1 of the wireless terminal 10 generates an acknowledgement (ACK) packet to which the ACK flag is set. The ACK packet is received by the proxy processor 73 of the WO #1 similar to the SYN packet.

Hence, the wireless terminal 10 may recognize communicating communicating with the server 50 but actually communicates with the proxy processor 73 of the WO #1. A communication procedure including transmission of a SYN packet, a return of a SYN/ACK packet and transmission of an ACK packet may be referred to as a “three-way handshaking”.

In response to a setting of a TCP session set by the wireless terminal 10, the proxy processor 73 of the WO #1 creates a socket for the virtual socket processor 74 of the WO #1 (process P100). The virtual socket processor 74 instructs the TCP-based protocol transmission processor 752T to set a session of the TCP-based protocol for the WO #2 (process P110).

The TCP-based protocol transmission processor 752T which has received the instruction performs the three-way handshaking with the TCP-based protocol reception processor 921T of the WO #2 and sets a connection of the TCP-based protocol.

The TCP-based protocol reception processor 921T of the WO #2 instructs the virtual socket processor 94 of the WO #2 to create a TCP socket. The virtual socket processor 94 that has received the instruction creates a TCP socket corresponding to the TCP socket created by the WO #1 (process P200).

Upon creating the TCP sockets by the virtual socket processors 74 and 94 of the WO #1 and the WO #2, the virtual socket processors 74 and 94 create UDP sockets, respectively (processes P111 and P201).

The UDP is a connectionless protocol and therefore is not necessary to perform the three-way handshaking. Hence, the virtual socket processor 74 of the WO #1 registers an address of the created UDP socket in the UDP-based transmission processor 752U and may finish the process. Similarly, the virtual socket processor 94 of the WO #2 registers the created address of a DUP socket in the UDP-based protocol reception processor 921U and may finish the process.

The virtual socket processor 94 of the WO #2 notifies to the proxy processor 95 that a listening socket set by the proxy processor 95 of the WO #2 has been accessed from outside (process P202).

The proxy processor 95 of the WO #2 accepts (or connects to) the listening socket (process P211) and sets a connection with the server 50 using the TCP to establish the connection with the server 50 (process P212). In this regard, the three-way handshaking is performed between the proxy processor 95 of the WO #2 and the server 50. This three-way handshaking is not illustrated in FIG. 19.

Upon creating the UDP sockets by the virtual socket processors 74 and 94 of the WOs #1 and #2, the quality measurers 756U and 756T in the WO #1 generate measurement packets and transmit the measurement packets to the upstream (process P112). For example, the quality measurer 756U generates measurement packets of the UDP-based protocol illustrated in FIG. 14, and the quality measurer 756T generates measurement packets of the TCP-based protocol illustrated in FIG. 15.

The measurement packets of the UDP-based protocol are received by the quality measurer 925U in the UDP-based protocol reception processor 921U of the WO #2. The measurement packets of the TCP-based protocol are received by the quality measurer 925T in the TCP-based protocol reception processor 921T of the WO #2.

The quality measurers 925U and 925T of the WO #2 measure the numbers of discarded packets, RTTs and available bandwidths of corresponding protocols based on the received measurement packets. The measurement result is notified to the quality measurers 756U and 756T of the WO #1 using, for example, the measurement result notification message illustrated in FIG. 18. Subsequently, measurement packets and measurement results may be periodically transmitted and notified, respectively.

The wireless terminal 10 starts transmitting TCP data packets upon establishing the connection with the server 50 (process P11). The data packets are transferred to the proxy processor 73 through the TCP processor 72 of the WO #1 (process P12). The proxy processor 73 of the WO #1 writes the data packets received from the TCP session into the virtual socket processor 74 again (process P13).

In this regard, it is assumed that measurement result indicate discard rate=0.0001% and RTT=150 ms. The measurement result is notified from the quality measurer 756U and 756T to the controller 78, for example. The controller 78 of the WO #1 refers to the protocol selection table 79A illustrated in FIG. 10 based on the measurement result.

In this case, the TCP-based protocol is available to achieve an average throughput higher than that of the UDP-based protocol. Therefore, the controller 78 determines to transmit data packets using the TCP-based protocol and notifies this determination to the virtual socket processor 74.

The virtual socket processor 74 has the common sequence number allocator 741 allocate a common sequence number to data packets received (or written) from the proxy processor 73 (process P113). The data packets allocated common sequence numbers are written into the TCP transmission socket buffer 751T (process P114).

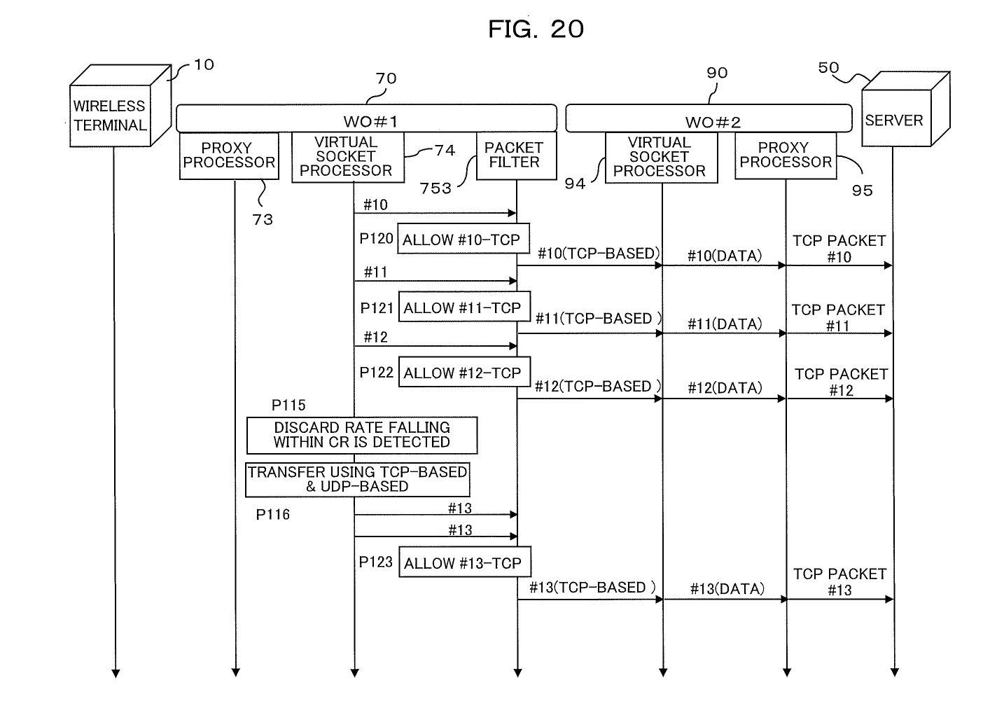

For example, FIG. 20 illustrates that the data packets #10 to #12 having the common sequence numbers #10 to #12 are written into the TCP transmission socket buffer 751T. The virtual socket processor 74 notifies the controller 78 of the common sequence numbers allocated to the data packets. The controller 78 updates the protocol selection table 79B illustrated in FIG. 11 for every notified common sequence number.

The data packets #10 to #12 written into the TCP transmission socket buffer 751T are read by the TCP-based protocol transmission processor 752T, are converted into data packets (see FIG. 13) of the TCP-based protocol, and are transferred to the packet filter 753.

Upon receiving the data packets from the TCP-based protocol transmission processor 752T, the packet filter 753 refers to the protocol designation table 79B illustrated in FIG. 11. In this regard, it is assumed that the data packets #10 to #12 having the common sequence numbers #10 to #12 to be transmitted by using the TCP-based protocol are designated in the protocol designation table 79B. Hence, the packet filter 753 allows the data packets #10 to #12 to be passed to the wireless IF 77 and transmits the data packets to the wireless access network 30 (processes P120 to P122).

The data packets #10 to #12 of the TCP-based protocol transmitted to the wireless access network 30 are received by the TCP-based protocol reception processor 921T of the WO #2. The TCP-based protocol reception processor 921T inversely converts the received data packets #10 to #12 to formats before the TCP-based protocol conversion to write the data packets #10 to #12 into the TCP reception socket buffer 922T in the order of the received data packets.

The data packets #10 to #12 written into the TCP reception socket buffer 922T are read in accordance with the order of the written data packets by the virtual socket processor 94. The virtual socket processor 94 extracts data (or payload) included in each of the data packets #10 to #12 and transfers the extracted data to the proxy processor 95.

The proxy processor 95 transfers the data received from the virtual socket processor 94 to the TCP processor 96, and the TCP processor 96 transmits the received data in the TCP session established for the server 50 through the wired IF 97.

In this regard, it is assumed that communication quality of the wireless access network 30 is deteriorated, and the controller 78 of the WO #1 obtains (or detects) a measurement result indicative of discard rate=0.001% and RTT=150 ms as a result of quality measurement periodically performed as described above. In this case, as illustrated in FIG. 20, the controller 78 determines (or detects) that the discard rate falls within the CR with reference to the protocol selection table 79A illustrated in FIG. 10 (process P115). The controller 78 instructs the virtual socket processor 74 to write data packets into both of the UDP transmission socket buffer 751U and the TCP socket buffer 751T in response to the determination.

Additionally, the controller 78 updates the protocol designation table 79B illustrated in FIG. 11 for every common sequence number subsequently allocated to data packets. As exemplarily illustrated in FIG. 11, the controller 78 updates the protocol designation table 79B such that the data packets #15 to #19 allocated the common sequence numbers #15 to #19 are to be transmitted by using the UDP-based protocol.

The virtual socket processor 74 allocates, by the common sequence number allocator 741, common sequence numbers to the data packets received from the proxy processor 73 to write the data packets into both of the transmission socket buffers 751U and 751T (process P116). For example, the virtual socket processor 74 writes the data packets #13 to #15 allocated the common sequence numbers #13 to #15 into both of the transmission socket buffers 751U and 751T.

Hence, the protocol transmission processors 752U and 752T read the same data packets #13 to #15 from the corresponding transmission socket buffers 751U and 751T, respectively. The protocol transmission processors 752U and 752T convert the read data packets #13 to #15 into data packets of a corresponding protocol (see FIGS. 12 and 13) to transfer the data packets #13 to #15 to the packet filter 753.

The packet filter 753 filters data packets to be outputted from the protocol transmission processors 752U and 752T to the wireless IF 77 with reference to the protocol designation table 79B illustrated in FIG. 11.

In this regard, the protocol designation table 79B is updated to transmit the data packets #10 to #14 using the TCP-based protocol and to transmit the subsequent data packets #15 to #19 . . . using the UDP-based protocol.

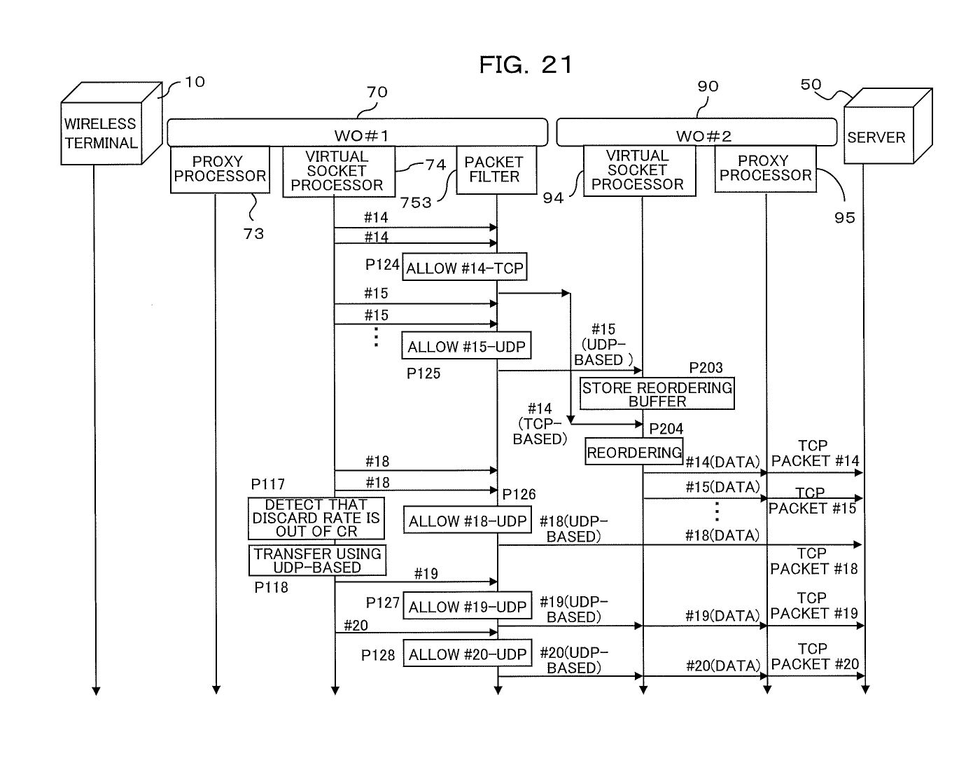

Hence, the packet filter 753 allows the data packets #13 and #14 received from the TCP-based protocol transmission processor 752T to be passed as illustrated in FIGS. 20 and 21 (processes P123 and P124). Further, the packet filter 753 discards data packets that are subsequent to the data packet #15 and that are received from the TCP-based protocol transmission processor 752T.

In contrast, the data packets #13 and #14 received from the UDP-based protocol transmission processor 752U are discarded by the packet filter 753. Further, the packet filter 753 allows the data packets that are subsequent to the data packet #15 and that are received from the UDP-based protocol transmission processor 752U to be pass (process P125).

The protocol transmission processors 752U and 752T, which have transmitted the data packets to the packet filter 753, hold the already transmitted data packets in the retransmission buffers 755U and 755T, respectively, in preparation for packet loss in the wireless access network 30.

When an acknowledge response for the data packets is not notified from the WO #2 for a predetermined period of time or more, the corresponding protocol transmission processor 752U or 752T retransmits the already transmitted data packets.

However, since an acknowledge response for the data packets discarded by the packet filtering in the packet filter 753 is not notified, unnecessary data packets are retransmitted.

The packet filter 753 gives a notification to cancel retransmission to a transmission source (the protocol transmission processor 752U or 752T) of the data packets intentionally discarded according to the protocol designation table 79B to prevent such unnecessary retransmission. The protocol transmission processor 752U or 752T, which has received the notification, deletes the data packets held in the retransmission buffer 755U or 755T.

By the way, the data packets #13 and #14 transmitted from the WO #1 using the TCP-based protocol, and the data packets including the data packet #15 and the subsequent data packets transmitted using the UDP-based protocol are supposed to be received by the WO #2 in the order of transmitted data packets. However, the reception order and the transmission order do not match in some cases depending on a traffic situation of the wireless access network 30.

For example, it is assumed that the reception processor 92 of the WO #2 receives the data packet #13 and then receives the data packet #15 prior to the data packet #14. In this case, the virtual socket processor 94 reads the data packet #15 of the UDP-based protocol from the UDP reception socket buffer 922U, and then reads the data packet #14 of the TCP-based protocol from the TCP reception socket buffer 922T.

Hence, the virtual socket processor 94 control (or correct), by the reordering processor 942, an order to transfer the received data packets to the proxy processor 95 based on the common sequence number. For example, when the reordering processor 942 reads the data packet #15 whose common sequence number is discontinuous with respect to the read data packet #13, the reordering processor 942 stores the data packet #15 in the reordering buffer 943 (process P203).

Thereafter, when the TCP reception socket buffer 922T reads the data packet #14, the reordering processor 942 transfers data (or payload) included in the data packet #14 to the proxy processor 95. Subsequently, the reordering processor 942 transfers the payload included in the data packet #15 stored in the reordering buffer 943 to the proxy processor 95. As described above, the reordering processor 942 corrects the reception order of the data packets to guarantee the transmission order of the data packets from the WO #1 (process P204).

The proxy processor 95 transfers the data (or payload) received from the virtual socket processor 94 to the TCP processor 96, and the TCP processor 96 transmits the received data in the TCP session established for the server 50 through the wired IF 97.

Next, it is assumed that communication quality of the wireless access network 30 is further deteriorated, and the controller 78 of the WO #1 obtains (or detects) a measurement result indicative of discard rate=0.01% and RTT=150 ms as a result of quality measurement periodically performed as described above.

The controller 78 refers to the protocol selection table 79A illustrated in FIG. 10 based on the measurement result and detects that the packet discard rate drops out from the CR in a direction indicative of a increase of the discard rate (process P117).

In this case, the controller 78 determines (or detects) with reference to the protocol selection table 79A that a higher average throughput than that of the TCP-based protocol is obtained by transmitting data packets using the UDP-based protocol.

In response to the above determination (or detection), the controller 78 instructs the virtual socket processor 74 to write the data packets into the UDP transmission socket buffer 751U corresponding to the UDP-based protocol. In other words, the controller 78 stops the redundant writing of the data packets into the transmission socket buffers 751U and 751T corresponding to each protocol.

In response to the instruction by the controller 78, the virtual socket processor 74 allocates common sequence numbers to the data packets received from the proxy processor 73 to write the data packets into the UDP transmission socket buffer 751U (process P118). For example, FIG. 21 illustrates that the data packet with the common sequence number #19 and the subsequent data packets are written into the UDP transmission socket buffer 751U.

The data packets written into the UDP transmission socket buffer 751U are read by the UDP-based protocol transmission processor 752U. The UDP-based protocol transmission processor 752U converts the read data packets into data packets of the UDP-based protocol (see FIG. 12) to transfer the data packets to the packet filter 753.

The packet filter 753 refers to the protocol designation table 79B illustrated in FIG. 11 to filters the data packets received from the UDP-based protocol transmission processor 752U according to the designations in the protocol designation table 79B.

For example, the protocol designation table 79B illustrated in FIG. 11 designates that the data packets having the common sequence number #19 and the subsequent common sequence numbers are to be transmitted by using the UDP-based protocol. Hence, the packet filter 753 allows the data packet #19 and the subsequent data packets to be passed to the wireless IF 77 to permit transmitting the data packets (processes P127 and P128).

The above example is a case where the packet discard rate changes. However, it is also possible to support a case where an average throughput changes depending on changes of the RTT or a case where the average throughput changes depending on both of changes of the packet discard rate and the RTT change. For example, the support may be realized by preparing a protocol selection table 120 (or 218) corresponding to a parameter indicative of communication quality such as a packet discard rate or a RTT.

Further, the above is an exemplary operation focusing upon the upstream. It may be considered that the same as the above exemplary operation would easily apply to an operation in the downstream, with making reasonable efforts (and without making any inventive efforts) by those skills in the art. For example, the exemplary operation in the downstream may be considered to correspond to an operation where the wireless terminal 10 and the server 50 are read as the server 50 and the wireless terminal 10, respectively and the WO #1 and the WO #2 are read as the WO #2 and the WO #1 in FIGS. 19 to 22.

(Exemplary Operation of Controller)

Next, an exemplary operation of the controller 78 of the WO #1 will be described with reference to FIG. 22.

In the WO #1, the common sequence number allocator 741 of the virtual socket processor 74 allocates common sequence numbers in units of a predetermined data size to the received data packets from the proxy processor 73. The predetermined data size may be set to a size in which the common sequence number is excluded from a MTU (Maximum Transmission Unit).

The virtual socket processor 74 may notify the allocated common sequence numbers to the controller 78 every time the common sequence number allocator 741 allocates the common sequence numbers to the data packets. Upon receiving the notification from the virtual socket processor 74 (process P51), the controller 78 refers to measurement results of communication quality periodically measured and updated by the quality measurers 756U and 756T (process P52).

The controller 78 obtains estimated throughputs of the UDP-based and TCP-based protocols with reference to the protocol selection table 79A based on the measurement result (process P53). Further, the controller 78 checks whether or not the measurement result (e.g. discard packet rate) falls within the CR (process P54).

When the measurement result does not fall within the CR (NO in the process P54), the controller 78 may determine whether or not the estimated throughput of the UDP-based protocol is higher than the estimated throughput of the TCP-based protocol (process P55).

It is assumed that the estimated throughput of the UDP-based protocol is equal to or lower than the estimated throughput of the TCP-based protocol in the determination result (No in the process P55). In this case, the controller 78 registers in the protocol designation table 79B that data packets with the common sequence numbers notified from the virtual socket processor 74 are to be transmitted by using the TCP-based protocol (process P61). Further, the controller 78 may instruct the virtual socket processor 74 to write the data packets with the current common sequence numbers exclusively into the TCP transmission socket buffer 751T among the transmission socket buffers 751U and 751T (process P62).

Meanwhile, when the estimated throughput of the UDP-based protocol is higher than the estimated throughput of the TCP-based protocol as a result of the determination in the process P55 (Yes in the process P55), the controller 78 performs the following processes P71 and P72.

For example, the controller 78 registers in the protocol designation table 79B that data packets with the common sequence numbers notified from the virtual socket processor 74 are to be transmitted by using the UDP-based protocol (process P71). Further, the controller 78 instructs the virtual socket processor 74 to write the data packets with the current common sequence numbers exclusively into the UDP transmission socket buffer 751U among the transmission socket buffers 751U and 751T (process P72).

In contrast to the above, when the measurement result falls within the CR in the process P54 (Yes in the process P54), the controller 78 may determine whether or not the estimated throughput of the UDP-based protocol is higher than the estimated throughput of the TCP-based protocol (process P56).

When the estimated throughput of the UDP-based protocol is equal to or lower than the estimated throughput of the TCP-based protocol in the determination result (No in the process P56), the controller 78 may perform the following processes P81 and P83.

For example, the controller 78 registers in the protocol designation table 79B that data packets with the common sequence numbers notified from the virtual socket processor 74 are to be transmitted by using the TCP-based protocol (process P81). Further, the controller 78 instructs the virtual socket processor 74 to write the data packets with the current common sequence numbers into both of the UDP transmission socket buffer 751U and the TCP transmission socket buffer 751T (process P83).

Meanwhile, when the estimated throughput of the UDP-based protocol is higher than the estimated throughput of the TCP-based protocol in the determination result in the process P56 (Yes in the process P56), the controller 78 may perform the following processes P82 and P83.

For example, the controller 78 registers in the protocol designation table 79B that data packets with the common sequence numbers notified from the virtual socket processor 74 are to be transmitted by using the UDP-based protocol (process P82). Further, the controller 78 instructs the virtual socket processor 74 to write the data packets with the current common sequence numbers into both of the UDP transmission socket buffer 751U and the TCP transmission socket buffer 751T (process P83).

As described above, the controller 78 adaptively controls the selection of the transmission socket buffers 751U and 751T into which the data packets are written, according to the measurement result of communication quality. Thereby, the wireless terminal 10 (WO #1) is possible to transmit data packets by using a suitable protocol corresponding to (or depending on) communication quality of the wireless access network 30. Thereby, it is possible to improve communication performance (e.g. average throughput) between the WO #1 and the WO #2.

Further, in the CR, data packets are redundantly written into both of the transmission socket buffers 751U and 751T. Thereby, it is possible to switch between the UDP-based and TCP-based protocols with a minimum time lag without causing packet loss.

The above exemplary operation is an operation focusing upon the controller 78 of the WO #1 in the upstream. It may be considered that the same as the above exemplary operation is easily applied to an operation of the controller 98 of the WO #2 in the downstream, with making reasonable efforts (and without making any inventive efforts) by those skills in the art.

### Second Embodiment

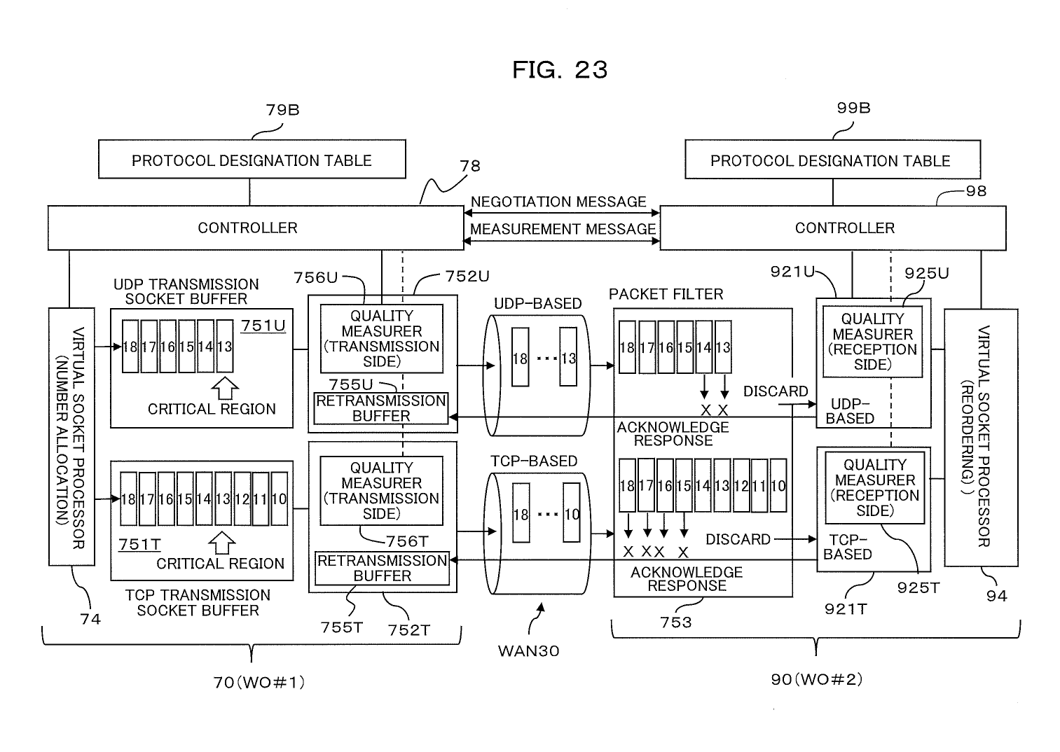

FIG. 23 is a block diagram illustrating an exemplary configuration of a communication system 1 according to a second embodiment. A configuration of the communication system 1 illustrated in FIG. 23 corresponds to a configuration where a packet filter 753 illustrated in FIGS. 6 and 8 is not provided in a WO #1 and is provided in a WO #2 instead, for example. In other words, although the packet filtering is performed by the transmission side WO #1 in the upstream in the first embodiment, the packet filtering may be performed by the reception side WO #2 in the upstream in the second embodiment.

Hence, in the WO #1 of the second embodiment, data packets written into both of transmission socket buffers 751U and 751T corresponding to each protocol are transferred from a virtual socket processor 74 of the WO #1 to the WO #2 by using each protocol without being filtered.

However, in the second embodiment, a controller 78 of the WO #1 is available to notify the contents of the protocol designation table 79B in the WO #1 to the WO #2 by exchanging a negotiation message with a controller 98 of the WO #2.

Hence, the controller 98 of the WO #2 is available to give the packet filter 753 of the WO #2 a instruction indicating which data packet with a common sequence number to be passed and which data packet with a common sequence number to be discarded, according to the notified contents of the protocol designation table 79B.

Thereby, the packet filter 753 is possible to selectively discard data packets of a protocol not being designated by the instruction from the controller 98. In this regard, the packet filter 753 may instruct the protocol reception processors 921U and 921T in the WO #2 not to request a retransmission of the discarded packet(s) to the WO #1.

The protocol reception processors 921U and 921T of the WO #2 may return to the WO #1 an acknowledge response packet with respect to the discarded packet notified from the packet filter 753 as if the discarded packet is successfully received. Upon receiving the acknowledge response packet, the protocol transmission processors 752U and 752T of the WO #1 may delete data packets held in the retransmission buffers 755U and 755T. Thereby, similar to the first embodiment, it is possible to cancel the retransmitting of data packets intentionally discarded by the packet filter 753 of the WO #2.

As described above, it is also possible to achieve the same function and effect as those of the first embodiment even though the packet filtering is performed in the reception side.

The same as that in the first embodiment would apply to the other operations (or processing) with making reasonable efforts and without making any inventive efforts by those skills in the art. Further, the above exemplary operation is an operation focusing on the upstream. The same as the above exemplary operation may also be applied to an operation in the downstream. For example, in the downstream, a packet filter may be unprovided to the transmission side WO #2, and a packet filter may be provided to the reception side WO #1 instead.

### Third Embodiment

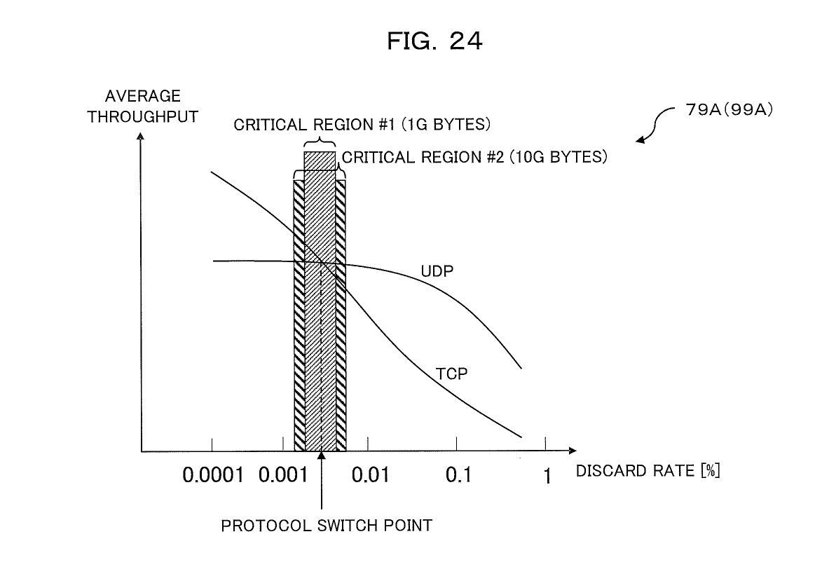

Next, a third embodiment will be described with reference to FIG. 24. FIG. 24 is a diagram illustrating a modified example of a protocol selection table 79A (99A) illustrated in FIG. 10. Data amounts available to be written into transmission socket buffers 751U and 751T of UDP-based and TCP-based protocols are dependent to a setting of the CR.

Hence, the CR may be variable depending on a size of a memory available in the transmission side WO #1 (or WO #2). For example, the CR may be set as illustrated in the following equation (2). In equation (2), “p” represents a discard rate (%), “T” represents a total size of one ore more memories (gigabyte(s)) available in the WO #1 (or WO #2), “N” represents the number of communication sessions managed by the WO #1 (or WO #2) (in other words, the number of the virtual sockets), and “M” represents a memory size per session represented by T/N (gigabyte(s)).

$$\begin{matrix}[ Equation 2 ] & \\ CR = p \pm {10}^{( log ( p ) - \frac{1}{M} )} [ \% ] & ( 2 )\end{matrix}$$

According to above equation (2), As the available memory size is larger, the CR is broader as illustrated in FIG. 24. FIG. 24 illustrates, for example, a CR #1 in a case where the available memory size is one gigabyte and a CR #2 in a case where the available memory size is ten gigabytes.

For example, it may be considered that the available memory sizes differ between the wireless base station 100 and the wireless terminal 10 and that the number of the sessions to be managed by the wireless base station 100 is larger than that of the wireless terminal 10. Hence, it is possible to optimize the CR in each of the wireless base station 100 and the wireless terminal 10 depending on the available memory sizes and the numbers of communication sessions to be managed. Therefore, it is possible to achieve the switching of the protocols suitable for the wireless base station 100 and the wireless terminal 10.

### Fourth Embodiment

The CR may be set as being variable according to a memory usage rate m (%) of the WO #1 (or WO #2) as expressed in the following equation (3).

$$\begin{matrix}[ Equation 3 ] & \\ CR = p \pm α \frac{( 100 - m ) M}{2 ( 2 w - s )} [ \% ] & ( 3 )\end{matrix}$$

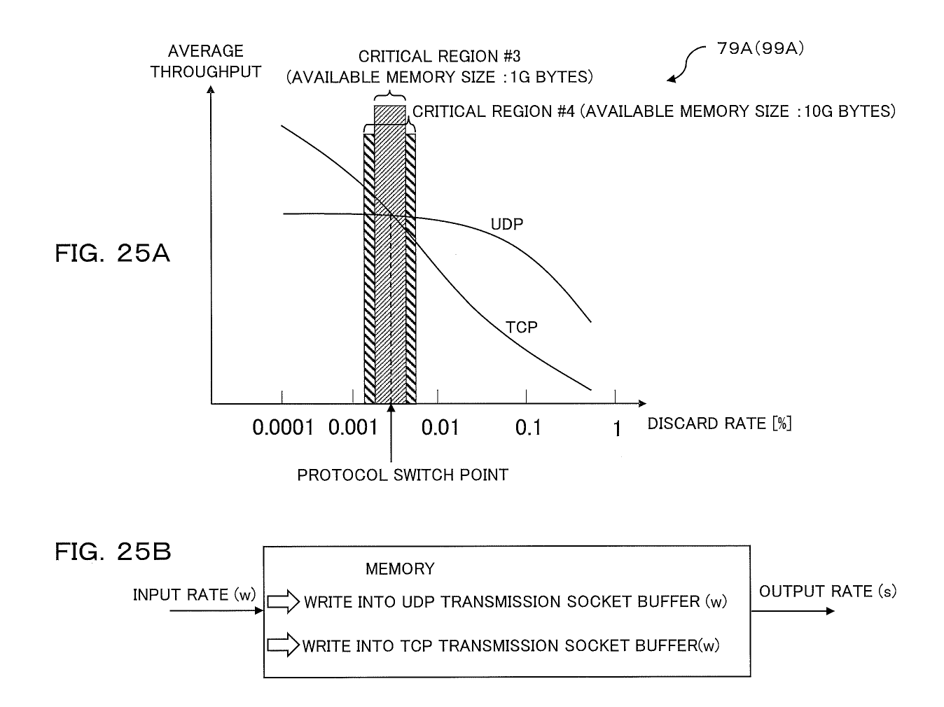

In equation (3), “a” represents a temporal change (or temporal differentiation) of a discard rate “p” expressed by equation (4). Further, in equation (3), “M” represents a memory size (gigabyte(s)) per session. Further, as schematically illustrated in FIG. 25B, “w” represents a data writing rate at which the virtual socket processor 74 (or 94) writes data into the transmission socket buffers 751U and 751T (or 931U and 931T). Further, “s” represents a data output (or transmission) rate to the WAN 30.

Here, it is assumed that the data writing rate (w) is the same as a data input rate to the virtual socket processor 74 (or 94). Further, it is assumed that the data transmission rate (s) to the WAN 30 is the same as a data reading rate from the transmission socket buffers 751U and 751T (or 931U and 931T).

Since input data of the input rate (w) is written into both of the transmission socket buffers 751U and 751T (or 931U and 931T) of the UDP and the TCP, data is written at a rate “2w” into the memory. Meanwhile, the written data decreases at a rate “s”. Hence, data is accumulated in the memory at a rate 2w−s.

When the memory usage rate is represented by “m”, the memory size of (100−m)M is available. Since data is accumulated in the memory at the rate 2w−s, it is available to accumulate data during t=(100−m)M/(2w−s) seconds. In this regard, since the temporal change of the discard rate p is “α”, even when the discard rate “p” changes by “α×(100−m)/(2w−s)”, it is available to accumulate data in the buffers. Equation (3) is obtained by dividing “α×(100−m)/(2w−s)” by two to equally distribute “α×(100−m)/(2w−s)” before and after a protocol switch point “p”.

According to above equation (3), as illustrated in FIG. 25A, as a memory usage rate (m) is lower (in other words, as an available memory size is larger), the CR is broader. FIG. 25A illustrates a CR #3 in a case where the available memory size is one gigabyte and a CR #4 in case where the available memory size is ten gigabytes, for example.

Therefore, similar to the third embodiment, it is possible to optimize the CR in each of the wireless base station 100 and the wireless terminal 10 depending on process capacity and the number of communication sessions thereof. Therefore, it is possible to achieve the switching of the protocols suitable for the wireless base station 100 and the wireless terminal 10.

### Fifth Embodiment

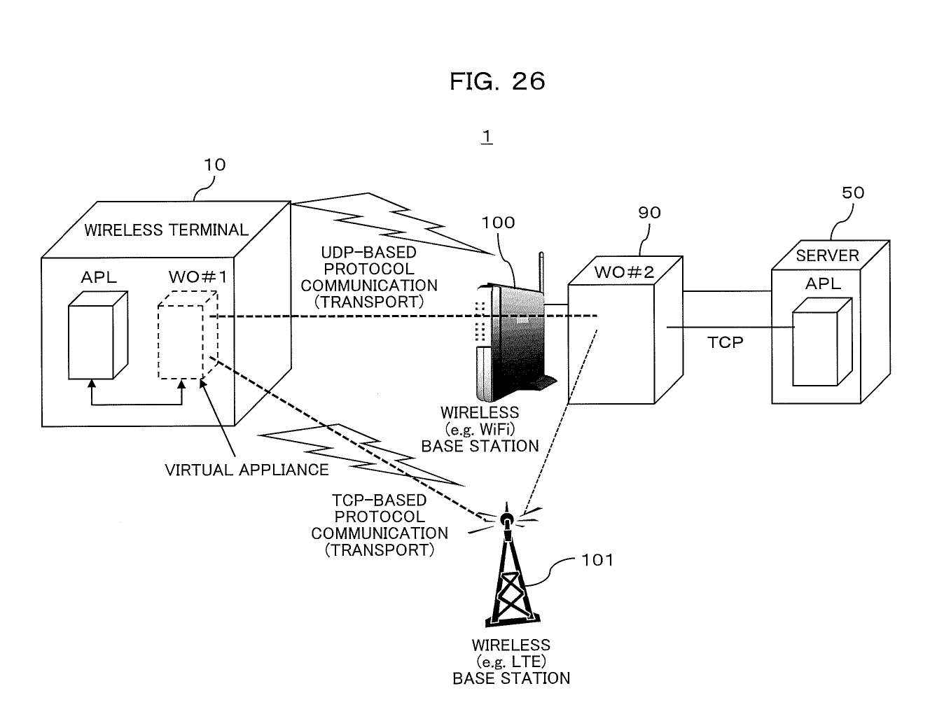

FIG. 26 is a block diagram illustrating an example of a communication system 1 according to a fifth embodiment. The communication system 1 illustrated in FIG. 26 differs from the configuration illustrated in FIG. 4 in that a second wireless base station 101 is provided in addition to a WiFi base station 100 which is an example of a first wireless base station.

An example of the second wireless base station 101 may be one supporting a standard such as LTE (Long Term Evolution) or LTE-Advanced. Hence, the wireless base station 101 may be referred to as the “LTE base station 101”.

The LTE base station 101 may be communicably connected with a WAN optimizer 90 (WO #2) using a cable. The LTE base station 101 is available to provide a wireless area in which wireless communication is available. The wireless area may also be referred to as a “coverage” or a “cell”. A cell may be a macrocell or a small cell (e.g. a femtocell, a picocell or a macrocell).

A wireless terminal 10, which is positioned in both of a wireless area provided by the WiFi base station 100 and a wireless area provided by the LTE base station 101, is available to access the server 50 through both of the wireless base stations 100 and 101 in the communication system 1 illustrated in FIG. 26. In other words, the wireless terminal 10 is possible to communicate with the server 50 through both of a WiFi line and a LTE line. The “line” may be referred to as a “path”, a “channel” or a “link”.

In this case, it is available to use different communication protocols for the WiFi line and the LTE line. For example, it is available to use the UDP-based protocol for the WiFi line and to use the TCP-based protocol for the LTE line in communication between a WO #1 and the WO #2.

In this regard, it is assumed that the WOs #1 and #2 communicate with each other by using the TCP-based protocol in the LTE line. In this case, when an interruption occurs in the LTE line due to movement of the wireless terminal 10 or occurrence of failure in the LTE line, the wireless terminal 10 is available to continue communicating with the server 50 in the WiFi line. However, the WO #1 and the WO #2 switch the TCP-based protocol used for the LTE line to the UDP-based protocol used for the WiFi line.

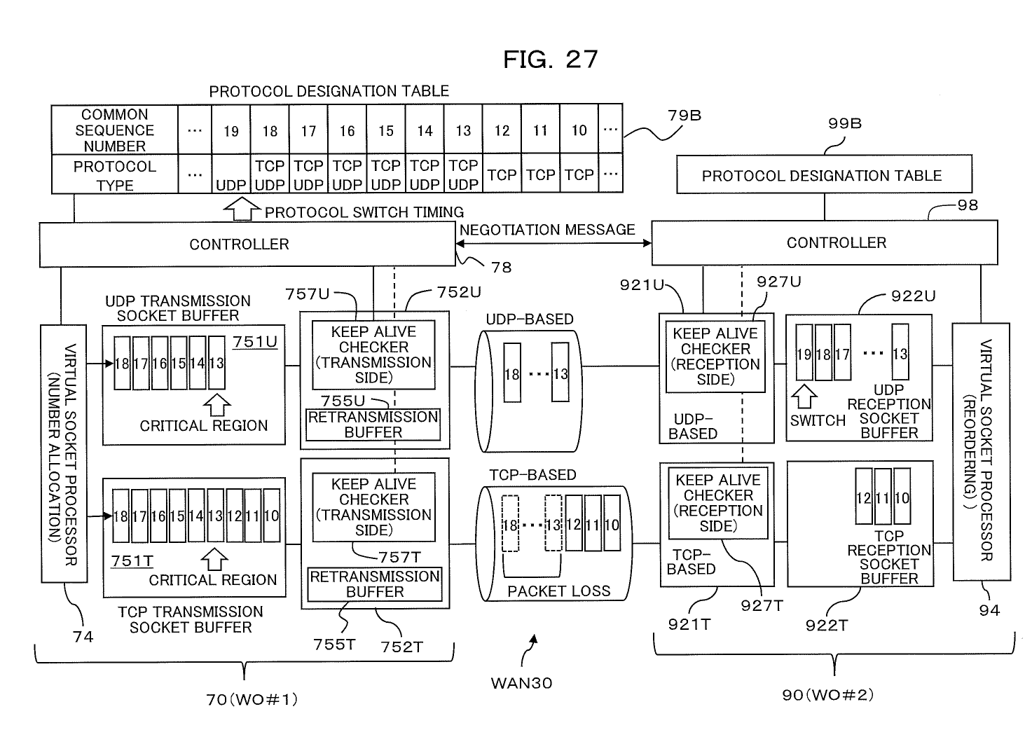

FIG. 27 illustrates configuration examples of the WO #1 and the WO #2 available to switch protocols depending on the above-described line switch. However, FIG. 27 illustrates the configuration examples of the WO #1 serving as a transmitter and the WO #2 serving as a receiver with focusing on the upstream, and a configuration example for the downstream is omitted in FIG. 27.

The WO #1 illustrated in FIG. 27 differs from the embodiments described above in that keep alive checkers 757U and 757T are provided in UDP-based and TCP-based protocol transmission processors 752U and 752T, respectively.

Further, the WO #2 illustrated in FIG. 27 differs from the above-described embodiments in that keep alive checkers 927U and 927T are provided in UDP-based and TCP-based protocol reception processors 921U and 921T, respectively.

Furthermore, the WO #1 and the WO #2 illustrated in FIG. 27 differ from the above-described embodiments in that the packet filter 753 and the protocol selection table 79A (99A) may be unprovided.

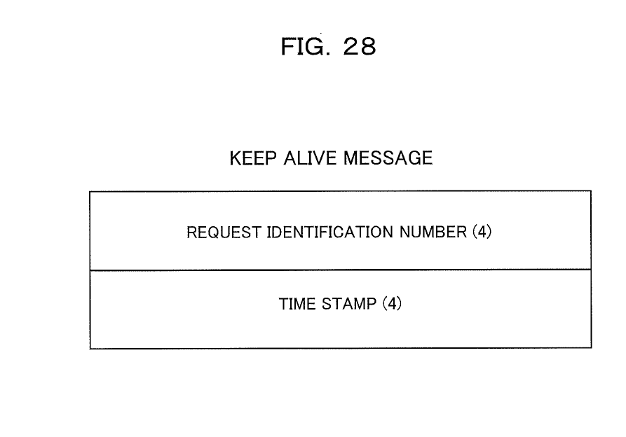

The keep alive checkers 757U and 757T of the WO #1 serving as the transmitter is available to periodically transmit keep alive messages illustrated in FIG. 28 to the WO #2 serving as the receiver. As illustrated in FIG. 28, the keep alive message may include an identification number (e.g. four bytes) available to identify a message (or request) and a time stamp (e.g. four bytes) indicative of a transmission time of the message.

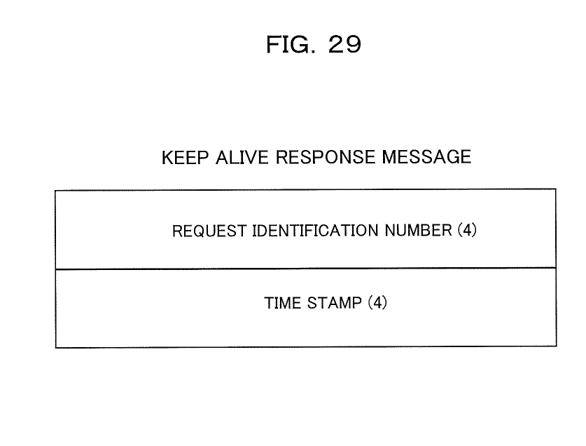

Upon receiving the keep alive message in each of the protocol reception processors 921U and 921T of the WO #2, each of the keep alive checkers 927U and 927T transmits a keep alive response message illustrated in FIG. 29 to the WO #1. As can be seen from comparison between FIGS. 28 and 29, each of the keep alive checkers 927U and 927T may copy and transmit contents of the received keep alive message as contents of the keep alive response message.

Upon detecting that no keep alive response message is successfully received within a predetermined time period after the keep alive message is sent, each of the keep alive checkers 757U and 757T in the WO #1 notifies a reception failure of the keep alive response message to a controller 78.

The controller 78 monitors the reception failure notification of the keep alive response messages for each of the TCP-based and UDP-based protocols. Upon detecting in the monitoring that the reception failure notification is sequentially received by a predetermined number of times, the controller 78 may determine that communication using a corresponding protocol is unavailable.

For example, when an interruption occurs in the LTE line as described above, since no keep alive response message is received using the TCP-based protocol, the controller 78 may determine that communication using the TCP-based protocol is unavailable. The threshold of the number of sequential reception failures of the keep alive messages, which allow the controller 78 to determine a corresponding communication is unavailable, may be set appropriately. For example, the threshold may be set to five times.

Meanwhile, when once the controller 78 receives the reception failure notification of the keep alive response message, the controller 78 may instruct the virtual socket processor 74 to write data packets received after the failure notification from the proxy processor 73 into both of the UDP transmission socket buffer 751U and the TCP transmission socket buffer 751T. Additionally, the controller 78 may register in the protocol designation table 79B that the data packets given the instruction to be written into both of the transmission socket buffers 751U and 751T are to be transmitted by using both of the UDP-based and TCP-based protocols.

For example, it is assumed that when the keep alive checker 757T in the TCP-based protocol transmission processor 752T transmits a data packet #12 allocated a common sequence number #12, the controller 78 detects a reception failure of a keep alive response message. In this case, the controller 78 instructs the virtual socket processor 74 to write a data packet #13 and data packet(s) subsequent to the data packet #13 into both of the transmission socket buffers 751U and 751T redundantly. Additionally, the controller 78 updates the protocol designation table 79B according to the redundant write instruction.

In the present embodiment, since the packet filter 753 is not provided in the WO #1, the data packets written into the transmission socket buffers 751U and 751T are transmitted to the WO #2 redundantly using both of the UDP-based and TCP-based protocols.

However, when the interruption occurs in the LTE line as described above, all of the data packet with the common sequence number #13 and the subsequent data packet(s) with the common sequence number subsequent to the common sequence number #13 in the TCP-based protocol are lost.

Thereafter, upon detecting that the number of sequential reception failures of the keep alive messages reaches the threshold of the predetermined number of times, the controller 78 of the WO #1 determines that communication using the TCP-based protocol is unavailable. In response to the determination, the controller 78 instructs the virtual socket processor 74 to switch a writing target of data packets received after the determination from the proxy processor 73 into the UDP transmission socket buffer 751U.

For example, it is assumed that a timing at which the number of sequential reception failures of the keep alive response messages reaches the threshold after the virtual socket processor 74 writes a data packet #18 into both of the transmission socket buffers 751U and 751T. In this case, the virtual socket processor 74 writes the data packet #19 and data packet(s) subsequent to the data packet #19 exclusively into the UDP transmission socket buffer 751U among the transmission socket buffers 751U and 751T according to the instruction from the controller 78. Further, the controller 78 registers in the protocol designation table 79B that the data packet #19 and the subsequent data packet(s) are to be transmitted by using the UDP-based protocol.

Meanwhile, the controller 78 of the WO #1 may notify the contents of the protocol designation table 79B to the controller 98 of the WO #2 by using a negotiation message. In other words, the controller 78 may notify to the controller 98 that data packets #13 to #18 are transmitted by using both of the UDP-based and TCP-based protocols and that the data packets subsequent to the data packet #18 are transmitted by switching a protocol to the UDP-based protocol. The WO #2 registers the notified contents of the protocol designation table 79B in a memory 302 as a protocol designation table 99B of the WO #2 (see FIG. 9).

In the WO #2, the TCP-based protocol reception processor 921T detects packet loss of the data packet #13 and the data packet(s) subsequent to the data packet #13 in the TCP-based protocol. However, as long as the UDP-based protocol reception processor 921U receives the data packet #13 and the data packet(s) subsequent to the data packet #13 in the UDP-based protocol, it may be determined that the data packet #13 and the data packet(s) subsequent to the data packet #13 are successfully received. Therefore, the TCP-based protocol reception processor 921T does not request a retransmission of the lost packet(s) to the WO #1. For this, the controller 98 may give a notification indicative of whether or not the data packet #13 and the data packet(s) subsequent to the data packet #13 are successfully received by the UDP-based protocol reception processor 921U in the UDP-based protocol to the TCP-based protocol reception processor 921T.

The controller 98 of the WO #2 is possible to recognize (or detect) that the data packet #19 and the data packet(s) subsequent to the data packet #19 are received in the UDP-based protocol with reference to the protocol designation table 99B. Thereby, the controller 98 may instruct the UDP-based protocol reception processor 921U to write each data (or payload) extracted from the data packet #19 and the data packet(s) subsequent to the data packet #19 into the UDP reception socket buffer 922U.

As described above, it is possible to appropriately switch the protocols according to a path switch between the wireless terminal 10 and the server 50 while preventing or minimizing delay in a manner similar to the above-described embodiments.

The above exemplary operation is directed to a protocol switch operation with focusing on the uplink. However, as additionally described in each of the above-described embodiments, a protocol switch operation in downlink is also available in the same way as that of the uplink in the above example.

### Sixth Embodiment

Each of the above-described embodiments explains a case where a protocol switch timing coincides with a boundary between data packets written into transmission socket buffers 751U and 751T (or 931U and 931T). However, the protocol switch timing and the boundary between the data packets may be different each other in some cases depending on a communication protocol. In such a case, the controller 78 (or 98) may adjust the protocol switch timing by delaying the protocol switch timing, for example.

As an example of a communication protocol possively causing a mismatch between a protocol switch timing and a boundary between data packets, there is a protocol that encodes transmission data using a redundant code to transmit the redundant-encoded data. A non-restrictive example of such a communication protocol is a protocol called a random parity stream (RPS).

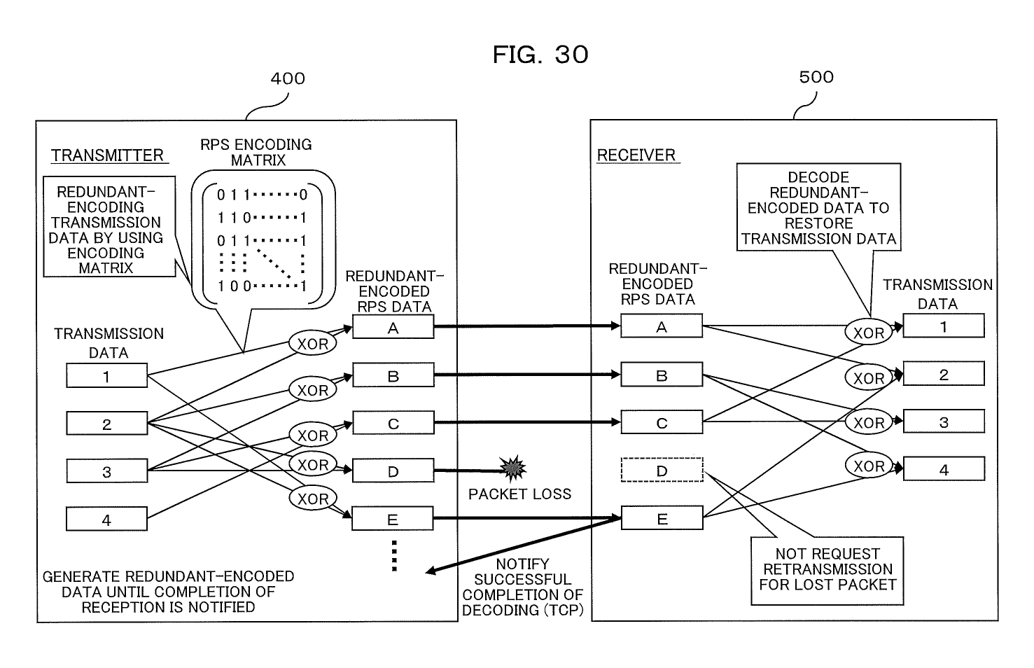

FIG. 30 schematically illustrates an outline of communication using the RPS. As illustrated in FIG. 30, a transmitter 400 generates redundant-encoded data (e.g. #A to #E) by performing an XOR on transmission data (e.g. #1 to #4) with an encoding matrix. This redundant-encoded data has a larger data size than an original data size of the transmission data since the redundant code is added to the transmission data. The transmitter 400 transmits the generated redundant-encoded data to a receiver 500.

The receiver 500 obtains (or decodes) the original transmission data by performing the XOR on the received redundant-encoded data again. According to the RPS, even when a part of redundant-encoded data is lost in a network (e.g. WAN 30), transmission data can be restored from redundant-encoded data included in other received packets.

Hence, the RPS achieves an advantage that a retransmission request is not needed for a certain amount of packet loss. An encoding matrix and an arithmetic operation method used to generate redundant-encoded data are not limited to the above, and other matrices and arithmetic operation methods are also be applicable.

In this regard, since the RPS performs the above redundant encoding, a size of transmission data is fixed. Hence, even when a protocol switch timing arrives in the first embodiment after data starts being written into each transmission socket buffer (whose reference numerals are omitted), for example, the timing and a boundary between series of transmission data are different in some cases.

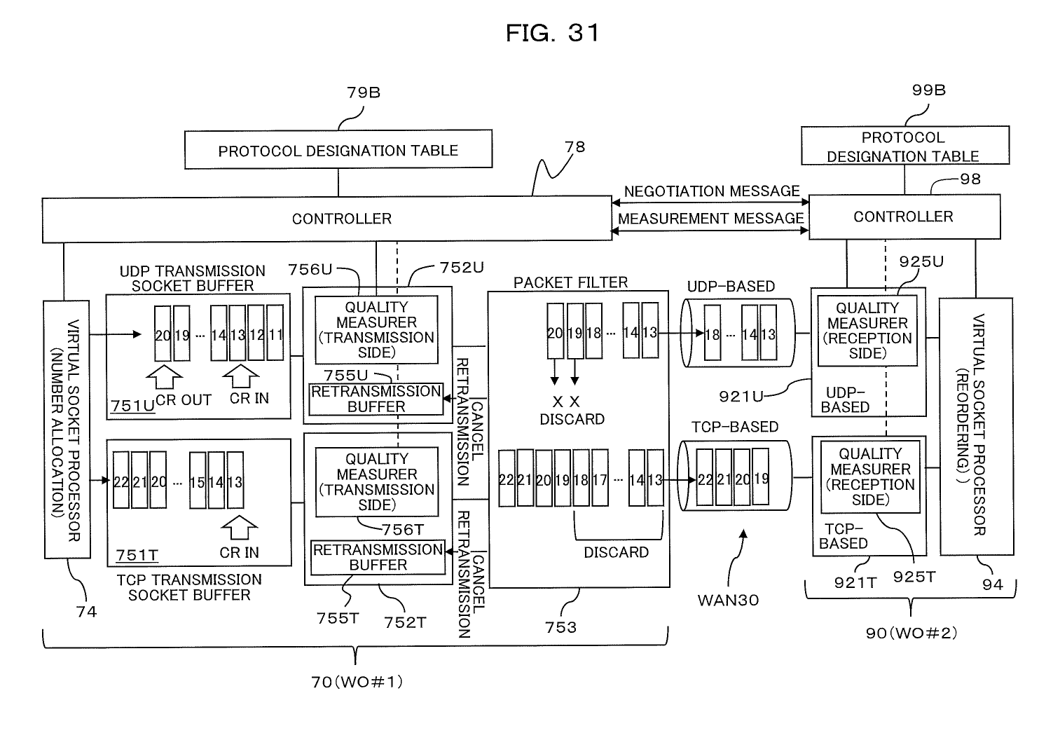

As exemplarily illustrated in FIG. 31, the controller 78 detects that a packet discard rate falls within the CR at a timing when a virtual socket processor 74 receives the data packet #13 with the common sequence number #13. FIG. 31 is a diagram corresponding to FIG. 8 in the first embodiment and illustrates configuration examples of a WO #1 serving as a transmitter and a WO #2 serving as a receiver with focusing on the upstream. An exemplary configuration for the downstream is omitted in FIG. 31 in a manner similar to FIG. 8.

In this case, the virtual socket processor 74 starts writing the data packet #13 and data packet(s) subsequent to the data packet #13 into both of the transmission socket buffers 751U and 751T.

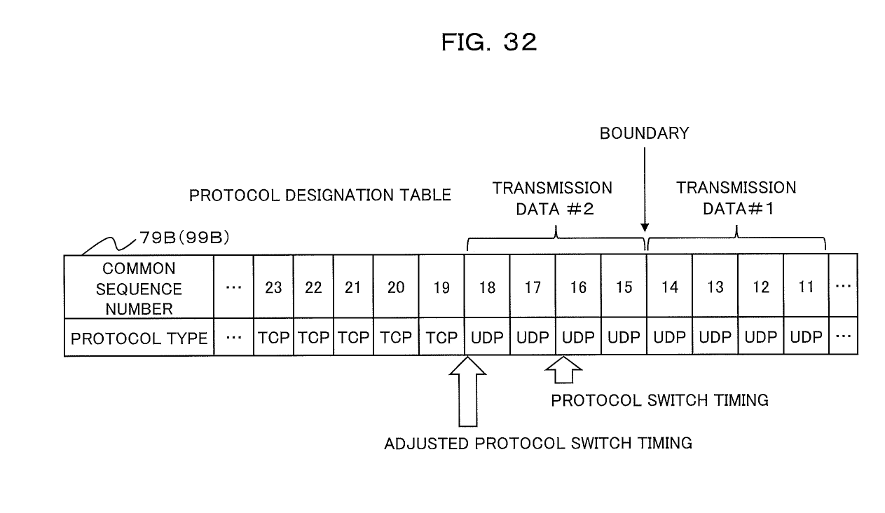

Further, as illustrated in FIG. 32, the controller 78 tries to perform a protocol switch at a timing (e.g. a writing timing of a data packet #16) when a packet discard rate reaches a protocol switch point (see also FIG. 10).

However, when the series of the data packets #11 to #14 configure first transmission data #1 and the series of data packets #15 to #18 configure second transmission data #2, the writing timing of the data packet #16 corresponds to a timing in the middle of writing the second transmission data #2.

Hence, as illustrated in FIG. 32, the controller 78 adjusts the protocol switch timing to a timing at which the writing of the final packet #18 configuring the second transmission data #2 is finished. Additionally, the controller 78 sets the adjusted timing to the protocol designation table 79B, for example.

While a discard rate falls within a range not exceeding the CR, the protocol switch timing may be set to the adjusted timing (hereinafter, may also be referred to as an adjusted protocol switch timing). Further, when the discard rate drops out from the CR in the middle of writing transmission data into the socket buffers, the controller 78 may continue writing this series of data into both of the socket buffers until the nearest boundary arrives, even though the discard rate drops out from the CR.

Subsequently, in response to a protocol selection based on the protocol selection table 79A according to a detection that the packet discard rate drops out from the CR in the controller 78, the virtual socket processor 74 switches a writing target to a transmission socket buffer corresponding to the selected protocol. In this case, the virtual socket processor 74 may also continue writing mid-write transmission data at the protocol switch timing until the boundary of the mid-write transmission data arrives.

The other operations (or processes) may be the same as those of the aforementioned embodiments. Further, FIG. 31 illustrates the exemplary operation with focusing on the upstream. However, as additionally described in each of the aforementioned embodiments, the above exemplary operation is also applicable to the downstream.

As described above, according to the sixth embodiment, it is possible to adjust a protocol switch timing according to a boundary between transmission data that is to be processed as one data and another transmission data. Accordingly, it is possible to achieve the same function and advantageous effect as those of each of the aforementioned embodiments and to prevent transmission data to be processed as one data from being transceived with an unsuitable protocol due to an unsuitable timing of the protocol switch.

(Others)

Although switching from the TCP-based protocol to the UDP-based protocol has been described above in each of the above embodiments, the reverse switch from the UDP-based protocol to the TCP-based protocol is also available in the same way as that in each of the above embodiments. Further, although an operation of switching between different TCP-based and UDP-based protocols has been described in each of the above embodiments, an operation of switching between the same protocols is also available in the same way as that in each of the above embodiments.

For example, the TCP-based protocol may be switched to another TCP-based protocol, and the UDP-based protocol may be switched to another UDP-based protocol. Further, although the switching between two UDP-based and TCP-based protocols has been described in each of the above embodiments, a switching between three or more protocols is also available in the same way as that in each of the above embodiments.

The above technique is possible to minimize a protocol switch time lag.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. A communication method that performs communication using any one of a first protocol and a second protocol, the communication method comprising:
performing, before detecting a protocol switch trigger, a redundant writing of transmission data of the first protocol into a transmission buffer for the first protocol, the transmission data being the same as transmission data of the second protocol; and
performing, upon detecting the protocol switch trigger, a protocol switch from the second protocol to the first protocol.

2. The communication method according to claim 1, wherein the transmission data is transmitted by a transmitter and the transmitter is configured to
measure communication quality with respect to a receiver that receives the transmission data, and
start the redundant writing of the transmission data into the transmission buffer in response to a detection of the measurement result falling within a predetermined communication quality range, the quality range including a point indicative of communication quality that causes the switch trigger.

3. The communication method according to claim 2, wherein the transmitter stops the redundant writing of the transmission data into the transmission buffer in response to a detection of the measurement result being out of the communication quality range.

4. The communication method according to claim 1, wherein the transmitter is configured to filter transmission data of the second protocol not being selected in response to the switch trigger from the transmission data sent by the first protocol and the second protocol.

5. The communication method according to claim 1, wherein
the transmitter is configured to transmit the transmission data redundantly written into the transmission buffer using the first protocol and the second protocol, and
the receiver is configured to filter transmission data of the second protocol not being selected in response to the switch trigger from the transmission data received by the first protocol and the second protocol.

6. The communication method according to claim 4, wherein
the transmitter is configured to
store the transmission data in a retransmission buffer in preparation for retransmission, and
delete the filtered transmission data from the retransmission buffer.

7. The communication method according to claim 1, wherein the transmitter is configured to correct a timing of the protocol switch according to a boundary of the transmission data being subjected to redundant encoding.

8. The communication method according to claim 1, wherein
the transmitter is configured to allocate a sequence number to the transmission data, the sequence number being independent to the first and second protocols, and
the receiver is configured to control a reception process of the transmission data based on the sequence number allocated to the received transmission data.

9. The communication method according to claim 8, wherein the reception process includes a process of reordering the received transmission data in order of data transmitted by the transmitter.

10. The communication method according to claim 1, wherein the first protocol is used in a first communication path and the second protocol is used in a second communication path, and the switch trigger is generated in response to a detection of an interruption of communication in the second communication path.

11. The communication method according to claim 1, wherein
the first protocol is based on a TCP (transmission control protocol); and
a second protocol is based on a UDP (user datagram protocol).

12. The communication method according to claim 2, wherein the communication quality range is set according to a size of a memory including the transmission buffer.

13. The communication method according to claim 2, wherein the communication quality range is set according to a usage rate of a memory including the transmission buffer.

14. A non-transitory computer-readable recording medium having recorded therein a communication control program of a communication apparatus that performs communication using any one of a first protocol and a second protocol, the communication control program causing a computer to execute a process comprising:
performing, before detecting a protocol switch trigger, a redundant writing of transmission data of the first protocol into a transmission buffer for the first protocol, the transmission data being the same as transmission data of the second protocol; and
performing, upon detecting the protocol switch trigger, a protocol switch from the second protocol to the first protocol.

15. A communication apparatus that performs communication using one of a first protocol and a second protocol, the communication apparatus comprising:
transmission buffers corresponding to the first and second protocols; and
a controller configured to
perform, before detecting a protocol switch trigger, a redundant writing of transmission data of the first protocol into the transmission buffer for the first protocol, the transmission data being the same as transmission data of the second protocol to be written into the other transmission buffer for the second protocol, and,
perform, upon detecting the protocol switch trigger, a protocol switch from the second protocol to the first protocol.
